(19) United States
(12) Patent Application Publication
(10) Pub. No.: US 2019/0141630 A1
(43) Pub. Date: May 9, 2019

(54) INDICATING VALIDITY OF A BROADCAST TARGET WAKE TIME SCHEDULE

(71) Applicant: QUALCOMM Incorporated, San Diego, CA (US)

(72) Inventors: Abhishek Pramod PATIL, San Diego, CA (US); George CHERIAN, San Diego, CA (US); Alfred ASTERJADHI, San Diego, CA (US); Yongchun XIAO, San Jose, CA (US); Sandip HOMCHAUDHURI, San Jose, CA (US)

(21) Appl. No.: 16/165,694

(22) Filed: Oct. 19, 2018

Related U.S. Application Data
(60) Provisional application No. 62/581,651, filed on Nov. 3, 2017.

(51) Int. Cl. H04W 52/02

(52) U.S. Cl. CPC H04W 52/0216; H04W 84/12; H04W 52/0229

(57) ABSTRACT

This disclosure provides systems, devices, apparatus and methods, including computer programs encoded on storage media, for a STA. The STA receives a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. In addition, the STA determines the validity of the first broadcast TWT parameter set based on the received first time duration. The STA may refrain from monitoring subsequent management frames (e.g., in order to sleep, to enter into a power saving mode, or to monitor other devices) that include the first broadcast TWT parameter set for a second time duration based on the first time duration.

### CROSS-REFERENCE TO RELATED APPLICATION(S)

This application claims the benefit of U.S. Provisional Application Ser. No. 62/581,651, entitled “TARGET WAKE TIME SIGNALING” and filed on Nov. 3, 2017, which is expressly incorporated by reference herein in its entirety.

### TECHNICAL FIELD

This disclosure relates generally to wireless communications, and more specifically, to indicating validity of a broadcast target wake time schedule.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or to maintain a communication link with the WLAN.

An AP may broadcast a target wake time (TWT) schedule. STAs that are participating in a broadcast TWT schedule, but not monitoring for an indication of a change in the broadcast TWT schedule frequently enough may miss receiving an indication of a broadcast TWT schedule change. STAs that monitor for an indication of a broadcast TWT schedule change with sufficient frequency not to miss the indication may use more power/energy than necessary. As such, there is currently a need to address issues associated with the indication of a broadcast TWT schedule change.

### SUMMARY

The systems, methods and devices of this disclosure each have several innovative aspects, no single one of which is solely responsible for the desirable attributes disclosed herein.

One innovative aspect of the subject matter described in this disclosure can be implemented in a first method for wireless communication. In an example, the first method may be performed by a wireless communication device at a STA. In some implementations, the STA receives a management frame including a first broadcast TWT parameter set associated with a broadcast TWT schedule identified by a first identifier (ID). The first broadcast TWT parameter set identifies a first time duration associated with a validity of the first broadcast TWT parameter set. The first broadcast TWT parameter set identifies at least four bits indicating the first time duration. The STA determines the validity of the first broadcast TWT parameter set based on the received first time duration.

The STA may refrain from monitoring subsequent management frames that include the first broadcast TWT parameter set for a second time duration based on the first time duration. When refraining from monitoring subsequent management frames, the STA may enter into a power saving mode for the second time duration. When entering into the power saving mode, the STA may enter into a sleep state in order to skip broadcast TWT service periods (SPs). The sleep state may be entered for the second time duration less than or equal to the first time duration. The management frame may be received from an AP. The STA may monitor signals from a device other than the AP or communicate with the device other than the AP. The STA may monitor signals from the device other than the AP or communicate with the device other than the AP concurrently with possible reception times of the subsequent management frames from the AP for the second time duration. When refraining from monitoring subsequent management frames, the STA may refrain from processing a portion of or an entire subsequent management frame.

The first time duration may indicate a number of intervals for which the first broadcast TWT parameter set is valid. Each interval of the intervals may be a beacon interval corresponding to a beacon frame, or a delivery traffic indication message (DTIM) interval corresponding to a beacon frame that includes a DTIM. The number of intervals may be a number of target beacon transmission times (TBTTs) of a beacon, or may be a number of beacons including a DTIM. The at least four bits may identify a value that indicates the number of intervals. The value may represent an integer number that is based on a linear function that represents up to 2^{N} intervals, where N is a number of bits of the at least four bits identifying the determined time duration, and N is greater than or equal to four.

The STA may receive subsequent first management frames each identifying a respective time duration, each time duration indicating a respective number of time intervals associated with the validity of the first broadcast TWT parameter set, wherein the number of intervals indicated by the respective time duration is decreased by one for each successive first management frame, and the broadcast TWT schedule is terminated after the time duration reaches zero. The STA may receive a subsequent second management frame between two successive first management frames. The second management frame may identify a time duration indicating a respective number of time intervals associated with the validity of the first broadcast TWT parameter set. The time duration identified in the second management frame may be unchanged relative to the time duration identified in the previously received first management frame. In a first configuration, each of the first management frames is a beacon frame, and the second management frame is one of a probe response frame, a broadcast probe response frame, an association response frame, a re-association response frame, or a fast initial link setup (FILS) discovery frame. In a second configuration, each of the first management frames is a beacon frame that includes a DTIM, and the second management frame is one of a probe response frame, a broadcast probe response frame, an association response frame, a re-association response frame, a FILS discovery frame, or a beacon frame that does not include a DTIM.

The STA may receive multiple subsequent management frames each identifying the first time duration associated with the validity of the first broadcast TWT parameter set. The first time duration may be an integer and may be at least one of (1) unchanged for the multiple subsequent management frame receptions while the first time duration is a finite time duration; (2) decreased by one each of the multiple subsequent management frame receptions; or (3) decreased or unchanged for a subset of the multiple management frame receptions, and subsequently increased for a last management frame reception of the multiple management frame receptions before the first time duration reaches zero. The management frame may be one of a probe response frame, a broadcast probe response frame, an association response frame, a re-association response frame, a FILS discovery frame, a beacon frame with a periodicity of a beacon interval, or a beacon frame with a periodicity of a DTIM interval. The management frame may further include a second broadcast TWT parameter set identified by the first ID. The first broadcast TWT parameter set may include a request type subfield indicating an alternate TWT. The second broadcast TWT parameter set may include a second request type subfield indicating an accept TWT. The request type subfield indicating alternate TWT may indicate that one or more parameters in the first broadcast TWT parameter set will change subsequent to expiration of the determined first time duration. The request type subfield indicating accept TWT may indicate a new parameter set in the second broadcast TWT parameter set that is applicable subsequent to expiration of the determined first time duration. The STA may communicate with an AP based on the broadcast TWT schedule.

Another innovative aspect of the subject matter described in this disclosure can be implemented in a second method for wireless communication. In an example, the second method may be performed by a wireless communication device at an AP. In some implementations, the AP determines a time duration associated with a validity of a first broadcast TWT parameter set associated with a broadcast TWT schedule identified by a first ID. The AP may generate the first broadcast TWT parameter set to identify the determined time duration. The first broadcast TWT parameter set may include at least four bits identifying the determined time duration. The AP may transmit a management frame including the generated first broadcast TWT parameter set.

The time duration may indicate a number of intervals for which the first broadcast TWT parameter set is valid. Each interval of the intervals may be a beacon interval corresponding to a beacon frame, or may be a DTIM interval corresponding to a beacon frame that includes a DTIM. The number of intervals may be a number of TBTTs of a beacon, or may be a number of beacons including a DTIM. The at least four bits may identify a value that indicates the number of intervals. The value may represent an integer number that is based on a linear function that represents up to 2^{N} intervals, where N is a number of bits of the at least four bits identifying the determined time duration, and N is greater than or equal to four. The AP may transmit subsequent first management frames each identifying a respective time duration. Each time duration may indicate a respective number of time intervals associated with the validity of the first broadcast TWT parameter set. The number of intervals indicated by the respective time duration may be decreased by one for each successive first management frame. The broadcast TWT schedule may be terminated after the time duration reaches zero. The AP may transmit a subsequent second management frame between two successive first management frames. The second management frame may identify a time duration indicating a respective number of time intervals associated with the validity of the first broadcast TWT parameter set. The time duration identified in the second management frame may be unchanged relative to the time duration identified in the previously transmitted first management frame. In a first configuration, each of the first management frames is a beacon frame, and the second management frame is one of a probe response frame, a broadcast probe response frame, an association response frame, a re-association response frame, or a FILS discovery frame. In a second configuration, each of the first management frames is a beacon frame that includes a DTIM, and the second management frame is one of a probe response frame, a broadcast probe response frame, an association response frame, a re-association response frame, a FILS discovery frame, or a beacon frame that does not include a DTIM.

The AP may transmit multiple subsequent management frames each identifying the time duration associated with the validity of the first broadcast TWT parameter set. The time duration may be an integer and may be at least one of (1) unchanged for the multiple subsequent management frame transmissions while the time duration is a finite time duration; (2) decreased by one each of the multiple subsequent management frame transmissions; or (3) decreased or unchanged for a subset of the multiple subsequent management frame transmissions, and subsequently increased for a last management frame transmission of the multiple subsequent management frame transmissions before the time duration reaches zero.

The management frame may be one of a probe response frame, a broadcast probe response frame, an association response frame, a re-association response frame, a FILS discovery frame, a beacon frame with a periodicity of a beacon interval, or a beacon frame with a periodicity of a DTIM interval. The AP may generate a second broadcast TWT parameter set identified by the first ID. The management frame may further include the generated second broadcast TWT parameter set. The first broadcast TWT parameter set may include a request type subfield indicating an alternate TWT. The second broadcast TWT parameter set may include a second request type subfield indicating an accept TWT. The request type subfield indicating alternate TWT may indicate that one or more parameters in the first broadcast TWT parameter set will change subsequent to expiration of the determined time duration. The request type subfield indicating accept TWT may indicate a new parameter set in the second broadcast TWT parameter set that is applicable subsequent to expiration of the determined time duration. The AP may communicate with at least one STA based on the broadcast TWT schedule.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram of an example AP for use in wireless communication.

FIG. 3 shows a block diagram of an example STA for use in wireless communication.

FIG. 4 shows a first diagram illustrating exemplary communication between an AP and a STA.

FIG. 5 shows a diagram illustrating an exemplary broadcast TWT element with multiple broadcast TWT parameter sets.

FIG. 6 shows a second diagram illustrating exemplary communication between an AP and a STA.

FIG. 7 shows a flowchart illustrating a first example process for a STA according to some implementations.

FIG. 8 shows a flowchart illustrating a second example process for a STA according to some implementations.

FIG. 9 shows a flowchart illustrating a third example process for a STA according to some implementations.

FIG. 10 shows a flowchart illustrating a fourth example process for a STA according to some implementations.

FIG. 11 shows a flowchart illustrating a first example process for an AP according to some implementations.

FIG. 12 shows a flowchart illustrating a second example process for an AP according to some implementations.

FIG. 13 shows a flowchart illustrating a third example process for an AP according to some implementations.

FIG. 14 shows a flowchart illustrating a fourth example process for an AP according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the IEEE 802.11 standards, the IEEE 802.15 standards, the Bluetooth® standards as defined by the Bluetooth Special Interest Group (SIG), the Long Term Evolution (LTE) standards including 3G and 4G standards, or New Radio (NR) standards including 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a WLAN, a wireless wide area network (WWAN), or an internet of things (TOT) network.

Various implementations relate generally to indicating validity of a broadcast TWT schedule. Some implementations more specifically relate to a STA receiving a management frame that includes a time duration indicating a guaranteed validity of the broadcast TWT schedule, and the STA determining a guaranteed validity of a broadcast TWT parameter set based on the received time duration. Further, some implementations more specifically relate to an AP determining a time duration associated with a guaranteed validity of a broadcast TWT schedule, generating a broadcast TWT parameter set to identify the determined time duration, and transmitting a management including the generated broadcast TWT parameter set.

Particular implementations of the subject matter described in this disclosure can be implemented to realize one or more of the following potential advantages. In some implementations, the described techniques can be used by a STA to refrain from monitoring some management frames in order to sleep longer than the STA would have been able to sleep otherwise, in order to save power at the STA, and/or in order to communicate with other devices (e.g., other STAs or other APs) concurrently while such management frames would have been received by the STA from an AP. In some implementations, the described techniques are used by an AP in order to facilitate the aforementioned potential advantages at the STA.

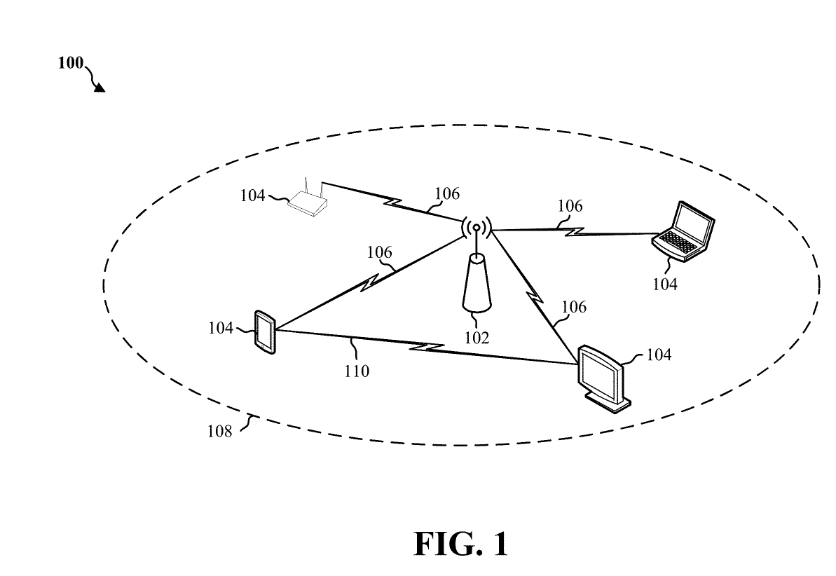

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy LTF (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

The AP 102, as well as some capable STAs 104, may support beamforming. For example, the AP 102 may use multiple antennas or antenna arrays to conduct beamforming operations for directional communications with a STA 104, and vice versa. Beamforming (which may also be referred to as spatial filtering or directional transmission) is a signal processing technique that may be used at a transmitter (for example, AP 102) to shape and/or steer an overall antenna transmission beam in the direction of a target receiver (for example, a STA 104). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 102 may communicate with the STA 104. That is, based on this CSI, the AP 102 may appropriately weight the transmissions from each antenna (for example or antenna port) such that the desired beamforming effects are achieved. In some cases, these weights may be determined before beamforming can be employed. For example, the transmitter (the AP 102) may transmit one or more sounding packets (for example, a null data packet) to the receiver in order to determine CSI.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

Some types of STAs 104 may support automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that can make use of the information, enable automated behavior of machines, or present the information to humans interacting with the program or application. Examples of applications for such devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct wireless link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

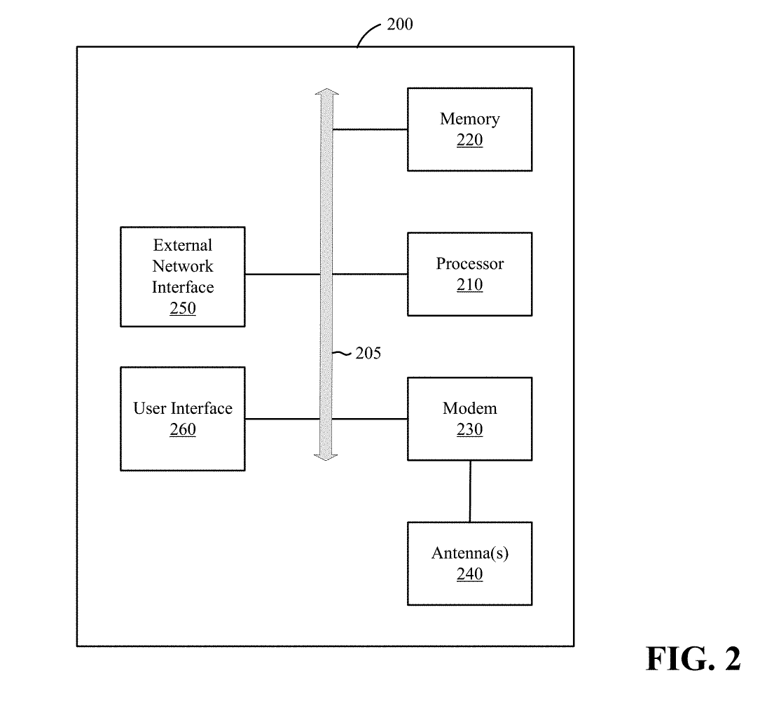

FIG. 2 shows a block diagram of an example access point (AP) 200 for use in wireless communication. For example, the AP 200 may be an example of aspects of the AP 102 described with reference to FIG. 1. The AP 200 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 200 includes at least one processor 210 (collectively “the processor 210”), at least one memory 220 (collectively “the memory 220”), at least one modem 230 (collectively “the modem 230”), at least one antenna 240 (collectively “the antenna 240”), at least one external network interface 250 (collectively “the network interface 250”) and, in some instances, a user interface (UI) 260. Each of the components (or “modules”) described with reference to FIG. 2 can communicate with other ones of the components, directly or indirectly, over at least one bus 205.

The processor 210 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 210 processes information received through the modem 230 and the external network interface 250. The processor 210 also can process information to be sent to the modem 230 for transmission through the antenna 240 and information to be sent to the external network interface 230. The processor 210 can generally be configured to perform various operations related to generating and transmitting a downlink frame and receiving an uplink frame.

The memory 220 can include random access memory (RAM) and read-only memory (ROM). The memory 220 also can store processor- or computer-executable software (SW) code containing instructions that, when executed by the processor 210, cause the processor to perform various functions described herein for wireless communication, including generation and transmission of a downlink frame and reception of an uplink frame.

The modem 230 is generally configured to modulate packets and to provide the modulated packets to the antenna 240 for transmission, as well as to demodulate packets received from the antenna 240 to provide demodulated packets. The modem 230 generally includes or is coupled with at least one radio frequency (RF) transmitter and at least one RF receiver, which may be combined into one or more transceivers, and which are in turn coupled to one or more antennas 240. For example, in some AP implementations, the AP 200 can include multiple transmit antennas (each with a corresponding transmit chain) and multiple receive antennas (each with a corresponding receive chain). The modem 230 can communicate bi-directionally, via the antenna 240, with at least one STA (such as the STA 104 described with reference to FIG. 1).

The modem 230 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 210 for processing, evaluation or interpretation, for example, by one or more host applications executing on the processor.

The AP 200 may communicate with a core or backhaul network through the external network interface 250 to gain access to external networks including the Internet. For example, the external network interface 250 may include one or both of a wired (for example, Ethernet) network interface or wireless (for example, LTE, 4G or 5G) network interface.

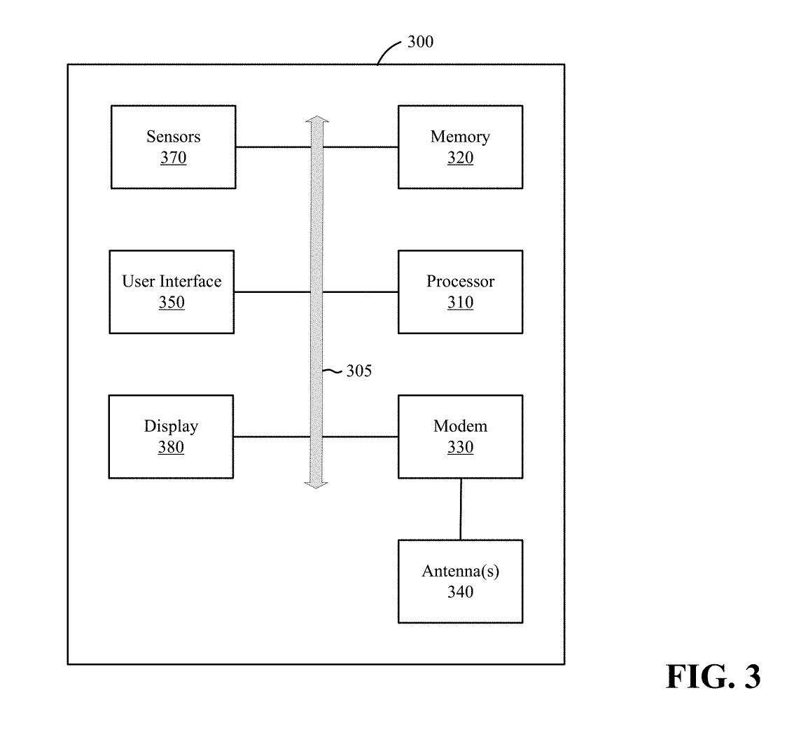

FIG. 3 shows a block diagram of an example wireless station (STA) 300 for use in wireless communication. For example, the STA 300 may be an example of aspects of the STA 104 or the STA 204 described with reference to FIGS. 1 and 2, respectively. The STA 300 is capable of transmitting and receiving wireless communications, as well as of encoding and decoding such communications. The wireless communications may conform to any of a number of different wireless communication protocols. For example, the STA 300 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 300 may be capable of transmitting and receiving Bluetooth packets conforming to a Bluetooth standard, such as defined in IEEE 802.15 or by the Bluetooth SIG. Additionally or alternatively, the STA 300 may be capable of transmitting and receiving wireless packets associated with the Long Term Evolution (LTE), International Mobile Telecommunications-Advanced (IMT-Advanced) 4G or 5G standards.

The STA 300 includes at least one processor 310 (collectively “the processor 310”), at least one memory 320 (collectively “the memory 320”), at least one modem 330 (collectively “the modem 330”) and at least one antenna 340 (collectively “the antenna 340”). In some implementations, the STA 300 additionally includes some or all of the following: a user interface (UI) 350 (such as a touchscreen or keypad), one or more sensors 370 (such as one or more inertial sensors, accelerometers, temperature sensors, pressure sensors, or altitude sensors), and a display 380. Each of the components (or “modules”) described with reference to FIG. 3 can communicate with one another, directly or indirectly, over at least one bus 305.

The processor 310 includes an intelligent hardware device such as, for example, a CPU, a microcontroller, an ASIC or a PLD such as an FPGA, among other possibilities. The processor 310 processes information received through the modem 330 as well as information to be sent to the modem 330 for transmission through the antenna 340. The processor 310 can be configured to perform various operations related to receiving a downlink frame and generating and transmitting an uplink frame.

The memory 320 can include RAM and ROM. The memory 320 also can store processor- or computer-executable SW code containing instructions that, when executed, cause the processor 310 to perform various functions described herein for wireless communication, including reception of a downlink frame and generation and transmission of an uplink frame.

The modem 330 is generally configured to modulate packets and provide the modulated packets to the antenna 340 for transmission, as well as to demodulate packets received from the antenna 340 to provide demodulated packets. The modem 330 generally includes at least one radio frequency (RF) transmitter and at least one RF receiver, which may be combined into one or more transceivers, and which are in turn coupled to one or more antennas 340. For example, in some implementations, the STA 300 can include multiple transmit antennas (each with a corresponding transmit chain) and multiple receive antennas (each with a corresponding receive chain). The modem 330 can communicate bi-directionally, via the antenna 340, with at least one AP (such as the AP 102 or AP 200 described with reference to FIGS. 1 and 3, respectively). As is described above, in some implementations, the modem also can communicate bi-directionally, via the antenna 340, with other STAs directly without the use of an intermediary AP.

The modem 330 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

In some examples, an AP (e.g., AP 102, 200, 402, 602) may be configured to broadcast a message (e.g., the broadcast TWT element 410, 510) that includes schedule information corresponding to one or more broadcast TWT schedules. In such examples, the message including schedule information corresponding to one or more TWT schedules may be referred to as a beacon or a broadcast TWT advertisement. For example, the beacon may include schedule information corresponding to one or more broadcast TWT schedules. A STA (e.g., STA 104, 300, 404, 604) may be configured to negotiate membership in or subscribe to one or more TWT schedules broadcasted by the AP by exchanging frames with the AP. Each of the one or more TWT schedules included in the beacon (i.e., each broadcast TWT schedule corresponding to information included in the beacon broadcasted by the AP) may be identified by an ID and/or the MAC address of the AP that broadcast the message. In some examples, the ID may be referred to as a broadcast TWT ID. The MAC address may be used in conjunction with the ID to enable multiple APs with overlapping coverage to use the same IDs for different broadcast TWT schedules without causing confusion, as STAs will be able to uniquely identify each broadcast TWT schedule using a respective TWT schedule ID and a MAC address corresponding to the AP that advertised the broadcast TWT schedules.

In some examples, in response to receiving a message from an AP that includes schedule information corresponding to one or more broadcast TWT schedules, the STA may be configured to generate and to transmit a message to the AP. The message transmitted to the AP may include information indicative of a subscription to one or more of the broadcast TWT schedules broadcasted by the AP (i.e., one or more broadcast TWT schedules corresponding to schedule information included in the beacon broadcasted by the AP). In such examples, the STA may be considered a member of the subscribed one or more broadcast TWT schedules and may be configured to operate in accordance therewith. A STA operating in accordance with a broadcast TWT schedule may be described as the STA having a membership in the broadcast TWT schedule. As an example, upon subscription to a particular broadcasted TWT schedule, the STA is configured to communicate with the AP in accordance with the subscribed particular broadcast TWT schedule. The AP may respond to the message including information indicative of a subscription to one or more of the broadcast TWT schedules broadcasted by the AP with a message that includes information indicative of acceptance of the one or more subscribed broadcast TWT schedules.

In other examples, messages transmitted to the AP by the STA may include information indicative of a request to become a member of or otherwise subscribe to one or more of the broadcast TWT schedules broadcasted by the AP (i.e., one or more broadcast TWT schedules corresponding to schedule information included in the beacon broadcasted by the AP). In such examples, the AP may respond to the message received from the STA with a message that includes information indicative of acceptance of one or more broadcast TWT schedules that the STA requested to join. Once subscribed, the STA may be considered a member of the subscribed one or more broadcast TWT schedules and may be configured to operate in accordance therewith. A STA operating in accordance with a broadcast TWT schedule may be described as the STA having a membership in the broadcast TWT schedule. As an example, upon subscription to a particular broadcasted TWT schedule, the STA is configured to communicate with the AP in accordance with the subscribed particular broadcast TWT schedule.

In other examples, the STA may be configured to transmit a message to the AP that does not include information indicative of a request to become a member of or otherwise subscribe to one or more of the broadcast TWT schedules broadcasted by the AP. Instead, as one example, the message may include information indicative of rejection of the one or more broadcast TWT schedules included in the beacon. As another example, the message may include information indicative of a broadcast TWT schedule different from the one or more beacons included in the beacon. In such an example, the broadcast TWT schedule included in the response message may be referred to as a suggested broadcast TWT schedule or a demanded broadcast TWT schedule, and may include information corresponding to the suggested broadcast TWT schedule or the demanded broadcast TWT schedule, respectively.

In some examples, an AP and/or a STA may be configured to suspend (e.g., pause) one or more broadcast TWT schedules of which the STA is a member or to which the STA is subscribed. In one example, the AP may be configured to generate and to transmit (e.g., unicast) a message to the STA including information indicative of suspending one or more broadcast TWT schedules. The information indicative of suspending one or more broadcast TWT schedules may include information that identifies each broadcast TWT schedule to be suspended (e.g., a broadcast TWT schedule ID for each broadcast TWT schedule to be suspended and/or a TWT flow ID that identifies one or more broadcast TWT schedules to be suspended). The information indicative of suspending one or more broadcast TWT schedules included in the message may include information that identifies each broadcast TWT schedule to be suspended. In some examples, the information that identifies each broadcast TWT schedule to be suspended may include a broadcast TWT schedule ID (e.g., one or more broadcast TWT IDs) and/or a TWT flow ID in a TWT flow ID field. In some examples, a flow ID may identify one or more broadcast TWT schedules (for example, a flow ID may identify a group of broadcast TWT schedules that share the same flow ID). In some examples, the TWT flow ID may only be used in the event that a broadcast TWT schedule ID is not present in the message. In these examples, the AP may be configured to inform the STA of the suspension of the one or more broadcast TWT schedules identified in the message. In some examples, such a message may include a TWT information field as described herein. The TWT information field may include the information indicative of suspending one or more broadcast TWT schedules.

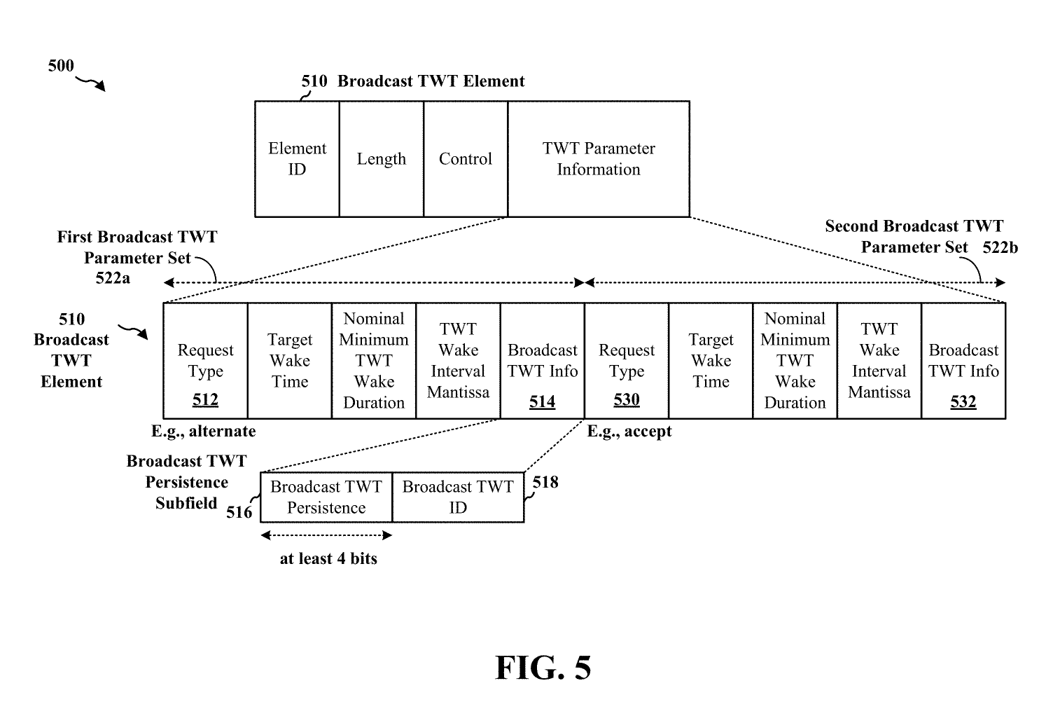

In another example, the STA may be configured to generate and to transmit (e.g., unicast) a message to the AP including information indicative of suspending one or more broadcast TWT schedules (e.g., see FIG. 5 and discussion related to an alternate TWT). The information indicative of suspending one or more broadcast TWT schedules may include information that identifies each broadcast TWT schedule to be suspended (e.g., a broadcast TWT schedule ID for each broadcast TWT schedule to be suspended and/or a TWT flow ID that identifies one or more broadcast TWT schedules to be suspended). The information indicative of suspending one or more broadcast TWT schedules included in the message may include information that identifies each broadcast TWT schedule to be suspended. In some examples, the information that identifies each broadcast TWT schedule to be suspended may include a broadcast TWT schedule ID (e.g., one or more broadcast TWT IDs) and/or a TWT flow ID in a TWT flow ID field. In some examples, a flow ID may identify one or more broadcast TWT schedules (for example, a flow ID may identify a group of broadcast TWT schedules that share the same flow ID). In some examples, the TWT flow ID may only be used in the event that a broadcast TWT schedule ID is not present in the message. In these examples, the STA may be configured to inform the AP of the suspension of the one or more broadcast TWT schedules identified in the message. For example, the STA may be informing the AP that even though the STA is subscribed to the one or more broadcast TWT schedules, the STA will not be operating in accordance with the one or more broadcast TWT schedules while the one or more broadcast TWT schedules are suspended. In some examples, such a message may include a TWT information field as described herein. The TWT information field may include the information indicative of suspending one or more broadcast TWT schedules. In the examples above, whether the suspension of one or more broadcast TWT schedules is initiated by the AP or the STA, the STA operating in accordance with the one or more broadcast TWT schedules that are being suspended may discontinue operating in accordance with the one or more broadcast TWT schedules until the one or more broadcast TWT schedules are resumed.

In some examples, an AP and/or a STA may be configured to resume one or more suspended broadcast TWT schedules to which the STA is subscribed. In one example, the AP may be configured to generate and to transmit (e.g., unicast) a message to the STA including information indicative of resuming the one or more suspended broadcast TWT schedules (e.g., see FIG. 5 and the discussion related to an accept TWT). The information indicative of resuming one or more broadcast TWT schedules may include information that identifies each broadcast TWT schedule to be resumed (e.g., a broadcast TWT schedule ID for each broadcast TWT schedule to be resumed and/or a TWT flow ID that identifies one or more broadcast TWT schedules to be resumed). The information indicative of resuming one or more broadcast TWT schedules included in the message may include information that identifies each broadcast TWT schedule to be resumed. In some examples, the information that identifies each broadcast TWT schedule to be resumed may include a broadcast TWT schedule ID (e.g., one or more broadcast TWT IDs) and/or a TWT flow ID in a TWT flow ID field. In some examples, a flow ID may identify one or more broadcast TWT schedules (for example, a flow ID may identify a group of broadcast TWT schedules that share the same flow ID). In some examples, the TWT flow ID may only be used in the event that a broadcast TWT schedule ID is not present in the message. The STA may be configured to resume operating in accordance with the one or more broadcast TWT schedules based on the message received from the AP. In some examples, such a message may include a TWT information field as described herein. The TWT information field may include the information indicative of resuming one or more broadcast TWT schedules.

In another example, the STA may be configured to generate and to transmit (e.g., unicast) a message to the AP including information indicative of resuming the one or more suspended broadcast TWT schedules (e.g., see FIG. 5 and the discussion associated with an accept TWT). The information indicative of resuming one or more broadcast TWT schedules may include information that identifies each broadcast TWT schedule to be resumed (e.g., a broadcast TWT schedule ID for each broadcast TWT schedule to be resumed and/or a TWT flow ID that identifies one or more broadcast TWT schedules to be resumed). The information indicative of resuming one or more broadcast TWT schedules included in the message may include information that identifies each broadcast TWT schedule to be resumed. In some examples, the information that identifies each broadcast TWT schedule to be resumed may include a broadcast TWT schedule ID (e.g., one or more broadcast TWT IDs) and/or a TWT flow ID in a TWT flow ID field. In some examples, a flow ID may identify one or more broadcast TWT schedules (for example, a flow ID may identify a group of broadcast TWT schedules that share the same flow ID). In some examples, the TWT flow ID may only be used in the event that a broadcast TWT schedule ID is not present in the message. The STA may be configured to resume operating in accordance with the one or more broadcast TWT schedules after sending the message to the AP. In some examples, such a message may include a TWT information field as described herein. The TWT information field may include the information indicative of resuming one or more broadcast TWT schedules.

In some examples, an AP may be configured to broadcast a message to inform one or more STAs that receive the broadcast of a suspension of one or more broadcast TWT schedules. The message may include information indicative of suspending one or more broadcast TWT schedules. The information indicative of suspending one or more broadcast TWT schedules may include information that identifies each broadcast TWT schedule to be suspended (e.g., a broadcast TWT schedule ID for each broadcast TWT schedule to be suspended). In such examples, each STA that receives the broadcasted message from the AP may be configured to suspend the one or more broadcast TWT schedules identified in the message. In some examples, such a message may include a TWT information field as described herein. The TWT information field may include the information indicative of suspending one or more broadcast TWT schedules.

In some examples, an AP may be configured to broadcast a message to inform one or more STAs that receive the broadcast of a suspension of all broadcast TWT schedules. The message may include information indicative of suspending all broadcast TWT schedules. In such examples, each STA that receives the broadcasted message from the AP may be configured to suspend all broadcast TWT schedules to which each respective STA is subscribed with the AP. In some examples, such a message may include a TWT information field as described herein. The TWT information field may include the information indicative of suspending one or more broadcast TWT schedules.

In some examples, an AP may be configured to broadcast a message to inform one or more STAs that receive the broadcast of a resumption of one or more suspended broadcast TWT schedules. The message may include information indicative of resuming one or more suspended broadcast TWT schedules. The information indicative of resuming one or more broadcast TWT schedules may include information that identifies each broadcast TWT schedule to be resumed (e.g., a broadcast TWT schedule ID for each broadcast TWT schedule to be resumed). In such examples, each STA that receives the broadcasted message from the AP may be configured to resume operating in accordance with the one or more broadcast TWT schedules based on the one or more broadcast TWT schedules identified in the message. In some examples, such a message may include a TWT information field as described herein. The TWT information field may include the information indicative of suspending one or more broadcast TWT schedules.

In some examples, an AP may be configured to broadcast a message to inform one or more STAs that receive the broadcast of a resumption of all suspended broadcast TWT schedules. The message may include information indicative of resuming all suspended broadcast TWT schedules. In such examples, each STA that receives the broadcasted message from the AP may be configured to resume all suspended broadcast TWT schedules to which each respective STA is subscribed with the AP. In some examples, such a message may include a TWT information field as described herein. The TWT information field may include the information indicative of suspending one or more broadcast TWT schedules.

A STA operating in accordance with the broadcast TWT schedule that is being suspended via the broadcasted message may receive the broadcasted message and discontinue operating in accordance with the broadcast TWT schedule based on receipt of the suspend message. The AP may be configured to resume the suspended broadcast TWT schedule by broadcasting a message including information indicative of resuming the suspended broadcast TWT schedule. Upon receiving the broadcasted message that includes information indicative of resuming the suspended broadcast TWT schedule, a STA may resume operating in accordance with the broadcast TWT schedule.

As described herein, a broadcast TWT schedule may include one or more SPs. Each SP may also be referred to as a TWT. In some examples, the one or more SPs may be between two beacons (i.e., a first beacon and a second beacon), which may be described as being between two TBTTs (i.e., a first TBTT and a second TBTT). In some examples, there may be zero or more beacons between the first and second beacon. The time from the first beacon to the second beacon may be referred to as a beacon interval. In other examples, a beacon interval may refer to the number of beacons between the first and second beacons plus one. Otherwise described, the beacon interval may refer to the total number of beacons including the first beacon, the second beacon, and any beacon between the first and second beacons minus one. For example, a beacon interval of 2 means that there is one beacon between the first and second beacons. As another example, a beacon interval of 3 means that there are 2 beacons between the first and second beacons.

When a STA (e.g., STA 104, 300, 404, 604) is subscribed to or otherwise operating in accordance with a broadcast TWT schedule, the STA may be configured to operate in a first state during an SP and a second state outside of an SP. In some examples, the first state may refer to a power consumption mode and the second state may refer to a power save mode. In such examples, a device (e.g., a STA, such as STA 104, 300, 404, 604) operating in the first state may refer to the device having its communication capability activated, turned on, not in power save mode (e.g., in power consumption mode), or the like. For example, the receiver of such a device may be turned on, not in power save mode (e.g., in power consumption mode), or the like. Similarly, a device (e.g. a STA, such as STA 104, 300, 404, 604) operating in the second state may refer to the device having its communication capability deactivated, turned off, in power save mode, or the like. For example the receiver of such a device may be turned off, in power save mode, or the like. Broadcast TWT schedules may allow an AP (e.g., AP 102, 200, 402, 602) and/or one or more STAs (e.g., STA 104, 300, 404, 604) to manage activity to minimize contention between the AP and the one or more STAs and/or to reduce an amount of time that a STA in a power save mode.

In accordance with the techniques described herein, a message that includes information corresponding to one or more broadcast TWT schedules (e.g., a message broadcasted by the AP including information corresponding to one or more broadcast TWT schedules and/or a message transmitted by a STA including information corresponding to a broadcast TWT schedule) may include information described herein. For ease of reference, the phrase “information corresponding to a broadcast TWT schedule” may be used to refer to information included in a message broadcasted by an AP or information included in a message transmitted by a STA to the AP. In some examples, information corresponding to a broadcast TWT schedule may be referred to as broadcast TWT schedule information.

In some examples, broadcast TWT schedule information may include information indicative of a lifetime of the broadcast TWT schedule. As described above, a message broadcasted by an AP may include a plurality of broadcast TWT schedules. In such examples, each respective broadcast TWT schedule includes respective information indicative of a respective lifetime of the respective broadcast TWT schedule.

In some examples, the AP (e.g., AP 102, 200, 402, 602) may be configured to generate and to transmit (e.g., broadcast) a message. The message may include broadcast TWT schedule information for one broadcast TWT schedule. In some examples, the message may include a TWT element that includes the broadcast TWT schedule information. The broadcast TWT schedule information may include information indicative of a lifetime of the broadcast TWT schedule corresponding to schedule information. In some examples, information indicative of a lifetime of a broadcast TWT schedule may be referred to as lifetime information, broadcast TWT persistence information, or the like.

In some examples, the AP (e.g., AP 102, 200, 402, 602) may be configured to generate and to transmit (e.g., broadcast) a message. The message may include broadcast TWT schedule information corresponding to a plurality of broadcast TWT schedules (e.g., two or more broadcast TWT schedules). In some examples, the message may include a TWT element that includes the broadcast TWT schedule information corresponding to a plurality of broadcast TWT schedules. The message may include broadcast TWT schedule information corresponding to a first broadcast TWT schedule and broadcast TWT schedule information corresponding to a second broadcast TWT schedule. However, in other examples, the message may include broadcast TWT schedule information corresponding to more than two broadcast TWT schedules. The broadcast TWT schedule information may include lifetime information corresponding to the first broadcast TWT schedule, and the schedule information may include lifetime information corresponding to the second broadcast TWT schedule. The broadcast TWT schedule information and the broadcast TWT schedule information are two examples of broadcast TWT schedule information corresponding to two broadcast TWT schedules of a plurality of broadcast TWT schedules. The plurality of broadcast TWT schedules may include two or more broadcast TWT schedules.

In some examples, each broadcast TWT schedule may be associated with its own respective lifetime information. However, in other examples, each broadcast TWT schedule may be associated with a single, common lifetime information. In such examples, instead of having the broadcast TWT schedule information corresponding to each broadcast TWT schedule include lifetime information, the message may include a single, common lifetime information. In such examples, even though only one instance of lifetime information may be included in a message, the lifetime information may apply to each broadcast TWT schedule information included in the message.

In some examples, the AP (e.g., AP 102, 200, 402, 602) may be configured to generate and to transmit (e.g., broadcast) a message. The message may include broadcast TWT schedule information corresponding to one or more broadcast TWT schedules. In some examples, the message may include a TWT element that includes the broadcast TWT schedule information corresponding to a plurality of broadcast TWT schedules. The broadcast TWT schedule information for each broadcast TWT schedule may include lifetime information. The lifetime information for each schedule information may be included in a broadcast TWT information field. The broadcast TWT information field may also include a broadcast TWT schedule ID (which may also be referred to as a broadcast TWT ID) corresponding to the broadcast TWT schedule associated with the broadcast TWT schedule information. The message may include a TWT element that includes the broadcast TWT schedule information corresponding to a plurality of broadcast TWT schedules.

In some examples, an AP may be configured to schedule a change to a broadcast TWT schedule that the AP has been advertising for one or more beacons. In such beacons, the AP may be configured to indicate that the broadcast TWT schedule is stable by, for example, having information that is indicative of an “Accept” TWT setup command in the Setup Command subfield of the Request Type field. Once the AP determines to make a change to the broadcast TWT schedule, the AP may be configured to indicate the change by modifying the “Accept” value in the Setup Command subfield to “Alternate.” In such examples, any message described herein may include information indicative of the change. In this way, a STA may be configured to determine when the upcoming change is to occur and what the change is. The STA may be configured to enter the first state or the second state at the time the broadcast TWT schedule change is scheduled to take place based on the information indicative of the change included in the message. In other examples, different values for the Setup Command subfield may be used to indicate the same information.

As one example, when the AP advertises a first broadcast TWT schedule (e.g., a first TWT parameter set) with a broadcast TWT schedule ID of X (where X is any ID) with Setup Command=alternate (i.e., information indicative of alternate in the setup command subfield of the Request Type field illustrated in FIGS. 2C-2F, the AP may also advertise a second broadcast TWT schedule (e.g., a second TWT parameter set) with the same ID (i.e., broadcast TWT schedule ID=X) but with a difference existing between at least one of the TWT parameters (the difference being the change to the schedule). With such a scheme, the receiving STA not only knows the time when the change would occur but also what the change would be. The AP may be configured to advertise the second broadcast TWT schedule with Setup Command=dictate (i.e., advertise the second broadcast TWT schedule with information indicative of “Dictate” setup command subfield). In other examples, different values for the Setup Command subfield may be used to indicate the same information.

In some examples, an AP may be configured to refrain from advertising the lifetime associated with a broadcast TWT schedule (or a STA may be configured to disregard any lifetime information included in a message) until the AP starts to advertise an upcoming change (e.g., modification or adjustment) to the broadcast TWT schedule. As set forth herein, the AP may be configured to schedule a change to a broadcast TWT schedule. In such examples, any message described herein may include information indicative of the change. In this way, a STA may be configured to determine when the upcoming change is to occur and what the change is. The STA may be configured to enter the first state or the second state at the time the broadcast TWT schedule change is scheduled to take place based on the information indicative of the change included in the message. For example, the Request Type field may include a Setup Command subfield that includes information indicative that the lifetime information is to be ignored (or disregarded) (e.g., when the information is indicative of an “Accept” TWT setup command), or information indicative that the lifetime information is to be regarded (or otherwise used) (e.g., when the information is indicative of an “Alternate” TWT setup command or a “Reject” setup command).

In some examples, an AP may be configured to indicate that one or more broadcast TWT schedules are stable by, for example, having information that is indicative of an “Accept” TWT setup command in the Setup Command subfield of the Request Type field.

As described herein, lifetime information may be a binary value among a plurality of possible binary values. In some examples, lifetime information may have a bit length of N bits. In such examples, the plurality of possible binary values may be 2^{N}. In such examples, each unique combination of bits of lifetime information may correspond to particular lifetime value or have a special meaning. Otherwise described, in some examples, the plurality of possible binary values may correspond to one or more of a plurality of lifetime values and/or one or more special meanings. The plurality of lifetime values may include a linear range of lifetime values (i.e., a range of lifetime values that increase or decrease linearly), a non-linear range of lifetime values (i.e., a range of lifetime values that increase or decrease non-linearly, such as exponentially). A lifetime value may correspond to a number of beacons (e.g., 1 beacon, 2 beacons, 5 beacons, or any number of beacons), a number of beacon intervals (e.g., 1 beacon interval, 2 beacon intervals, 5 beacon intervals, or any number of beacon intervals), a number of DTIM intervals (e.g., 1 DTIM interval, 2 DTIM intervals, 5 DTIM intervals, or any number of DTIM intervals), or any time unit (e.g., 1 millisecond, 2 milliseconds, 5 milliseconds, or any other period of time). A beacon interval may include two or more beacons. A DTIM interval may include two or more beacon intervals.

For example, table 1 below illustrates an example 3-bit encoding data structure for an example where the lifetime information has a bit length of 3 that maps lifetime information to a corresponding lifetime value. While this example provides a 3-bit encoding structure, the encoding data structure may be at least 4 bits in one configuration, and 8 or more bits in another configuration. In the example of table 1, the lifetime information of 111 corresponds to a special meaning. For example, where lifetime information is 111 in this example, the lifetime information of 111 may refer to the broadcast TWT schedule corresponding to broadcast TWT schedule information as never expiring. The special meaning may be mapped to lifetime information that is different from 111 in other examples. In such an example, the lifetime information of 111 may be described as mapping to a lifetime value of infinite. Referring to the example of table 1, the lifetime information 000 maps to a lifetime value of 5 beacons. Similarly, lifetime information 001 corresponds to a lifetime value of 10 beacons. In the example of table 1, each lifetime information (i.e., 000 through 111) may be described as encoding its respective lifetime value. Otherwise described, the lifetime value of 5 beacons is encoded as a 000, the lifetime value of 10 beacons is encoded as 001, and so on. The plurality of lifetime values in the example of table 1 includes one linear range of lifetime values and one lifetime value of a special meaning. The linear range extends from 5 beacons to 35 beacons.

TABLE 1
3-Bit Encoding Data Structure

| Lifetime | |
|---|---|
| Information | Lifetime Value |
| 000 | 5 beacons |
| 001 | 10 beacons |
| 010 | 15 beacons |
| 100 | 20 beacons |
| 101 | 25 beacons |
| 110 | 30 beacons |
| 011 | 35 beacons |
| 111 | Special Meaning M |

As another example, table 2 below illustrates an example 3-bit encoding data structure for an example where the lifetime information has a bit length of 3 that maps lifetime information to a corresponding lifetime value. In the example of table 2, the lifetime information of 111 corresponds to a special meaning. For example, where lifetime information is 111 in this example, the lifetime information of 111 may refer to the broadcast TWT schedule corresponding to broadcast TWT schedule information as never expiring. The special meaning may be mapped to lifetime information that is different from 111 in other examples. In such an example, the lifetime information of 111 may be described as mapping to a lifetime value of infinite. As another example, where lifetime information is 010, the lifetime information of 010 may refer to the broadcast TWT schedule corresponding to broadcast TWT schedule information as expiring or otherwise being valid for 250 beacons. In such an example, a STA (e.g., STA 104, 300, 404, 604) may receive the broadcast TWT schedule information including the lifetime information 010 from an AP (e.g., AP 102, 200, 402, 602). The STA may be configured to operate in accordance with the broadcast TWT schedule corresponding to the schedule information. The lifetime information 010 may inform the STA that the broadcast TWT schedule corresponding to the schedule information is valid for a mapped lifetime value (in this example, 250 beacons), meaning that the TWT expires after 250 beacons are transmitted by the AP (or a time period corresponding to or equivalent to the transmission of 250 beacons). Based on the lifetime information, the STA may be configured to determine when the broadcast TWT schedule corresponding to the broadcast TWT schedule information expires. In some examples, the STA may be configured to determine that the broadcast TWT schedule corresponding to the broadcast TWT schedule information expires at a particular beacon (i.e., at a certain TBTT associated with the particular beacon) or at a particular time based on the lifetime information. For example, upon joining, subscribing to, or otherwise becoming a member of the broadcast TWT schedule corresponding to the broadcast TWT schedule information, the STA may be configured to initiate a countdown based on the lifetime information. For example, if the lifetime information corresponds to a lifetime value of 2 beacons (e.g., two TBTTs), the STA may be configured to reduce the value of 2 by one upon the occurrence of the next TBTT, and subsequently reduce the lifetime value by one again upon the occurrence of the next subsequent TBTT. The STA may be configured to enter a first state as described herein so that the STA can receive a beacon upon expiration of the broadcast TWT schedule corresponding to the broadcast TWT schedule information.

As another example, where lifetime information is 110, the lifetime information of 110 may refer to the broadcast TWT schedule corresponding to broadcast TWT schedule information as expiring or otherwise being valid for 5 DTIM intervals. As described herein, based on a lifetime value associated with a broadcast TWT schedule to which a STA belongs, the STA may be configured to determine when the broadcast TWT schedule corresponding to the broadcast TWT schedule information expires.

Referring to the example of table 2, the lifetime information 000 maps to a lifetime value of 50 beacons. Similarly, lifetime information 001 corresponds to a lifetime value of 100 beacons and the lifetime information 101 corresponds to a lifetime value of 25 beacon intervals. In the example of table 2, each lifetime information (i.e., 000 through 111) may be described as encoding its respective lifetime value. While this example provides a 3-bit encoding structure, the encoding data structure may be at least 4 bits in one configuration, and 8 or more bits in another configuration.

TABLE 2
3-Bit Encoding Data Structure

| Lifetime | |
|---|---|
| Information | Lifetime Value |
| 000 | 50 beacons |
| 001 | 100 beacons |
| 010 | 250 beacons |
| 100 | 10 beacon intervals |
| 101 | 25 beacon intervals |
| 110 | 5 DTIM intervals |
| 011 | 500 time units |
| 111 | Special Meaning |

In some examples, lifetime information may map or otherwise correspond to an assured or guaranteed lifetime value and an unassured or unguaranteed lifetime value. As used herein, an assured or guaranteed lifetime value may refer to the minimum lifetime of the broadcast TWT schedule corresponding thereto, the minimum lifetime referring to a period (whether measured by one or more beacons, beacon intervals, DTIM intervals, time, or any other unit of the lifetime value) during which the broadcast TWT schedule corresponding thereto cannot be adjusted by the AP. For example, adjustment of a broadcast TWT schedule may include suspension of the broadcast TWT schedule and/or changing one or more parameters associated with the broadcast TWT schedule. An unassured or unguaranteed lifetime value may refer to a period of the broadcast TWT schedule corresponding thereto during which the broadcast TWT schedule can be adjusted by the AP.

Table 3 below illustrates an example 8-bit encoding data structure for an example where the lifetime information has a bit length of 8 that maps lifetime information to a corresponding lifetime value. In the example of table 3, the lifetime information 00000001 maps to a lifetime value of 100 assured beacons and 250 total beacons, meaning that of the 250 beacon lifetime, a lifetime value of 00000001 corresponding to a particular broadcast TWT schedule means that the particular broadcast TWT schedule is valid and cannot be adjusted for at least 100 beacons. However, taking the total lifetime of 250 and subtracting the assured number beacons results in a 150 beacon count, meaning that the particular broadcast TWT schedule is valid for another 150 beacons following the first 100 beacons unless the AP adjusts the particular broadcast TWT schedule before expiring at 250 beacons. In such examples, when two lifetime values correspond to lifetime information, the smaller value may correspond to the assured portion of the lifetime and the larger value minus the smaller value may correspond to the unassured portion of the lifetime.

TABLE 3
8-Bit Encoding Data Structure

| Lifetime | |
|---|---|
| Information | Lifetime Value |
| 00000000 | Special Meaning |
| 00000001 | 100 beacons (assured) |
| | 250 beacons |
| 00000010 | 250 beacons |
| 00000100 | Special Meaning |
| 00001000 | 25 beacon intervals (assured) |
| | 35 beacon intervals |
| 00010000 | 5 DTIM intervals |
| . . . | . . . |
| 11111111 | Special Meaning |

In some examples, the AP (e.g., AP 102, 200, 402, 602) may be configured to generate and to transmit (e.g., broadcast) a message. The message may include broadcast TWT schedule information for one broadcast TWT schedule. In some examples, the message may include a TWT information field that includes the broadcast TWT schedule information. The broadcast TWT schedule information may include information indicative of suspending one or more broadcast TWT schedules and/or resuming one or more broadcast TWT schedules.

An AP may schedule a broadcast TWT in order to broadcast information (e.g., in a downlink (DL) multiuser (MU) physical layer protocol data unit (PPDU)) to a STA. The AP may provide the schedule and set of parameters associated with the schedule for the broadcast TWT within a broadcast TWT element in a beacon frame. When the AP determines to change the set of parameters associated with the broadcast TWT schedule, the AP may provide within the broadcast TWT element a short notice (e.g., 6 or less beacon intervals) to STAs that the set of parameters associated with the broadcast TWT schedule will change. If a beacon interval is 100 ms, STAs may have 600 ms or less notice that the set of parameters associated with the broadcast TWT schedule will change. In one example, STAs that are not monitoring for the notice (e.g., in a sleep/power saving state, or otherwise not monitoring for the notice) may miss reception of the notice indicating a change in the set of parameters associated with the broadcast TWT schedule. In such situation, a STA must perform extra procedures to obtain the new set of parameters associated with the new broadcast TWT schedule once the STA wakes or otherwise begins monitoring again. In a second example, STAs may be forced to monitor the broadcast TWT element at least every half second or so in order to make sure that notices of broadcast TWT parameter changes are not missed. In such situation, being forced to monitor the broadcast TWT element may reduce a sleep duration of a STA and/or reduce an available time that such STA may monitor/communicate with other APs or other networks when such monitoring/communication occurs concurrent with the broadcast TWT element that may carry such notice. Currently, there is a need to address the aforementioned issues associated with the limited notice of broadcast TWT parameter set changes associated with a broadcast TWT schedule.

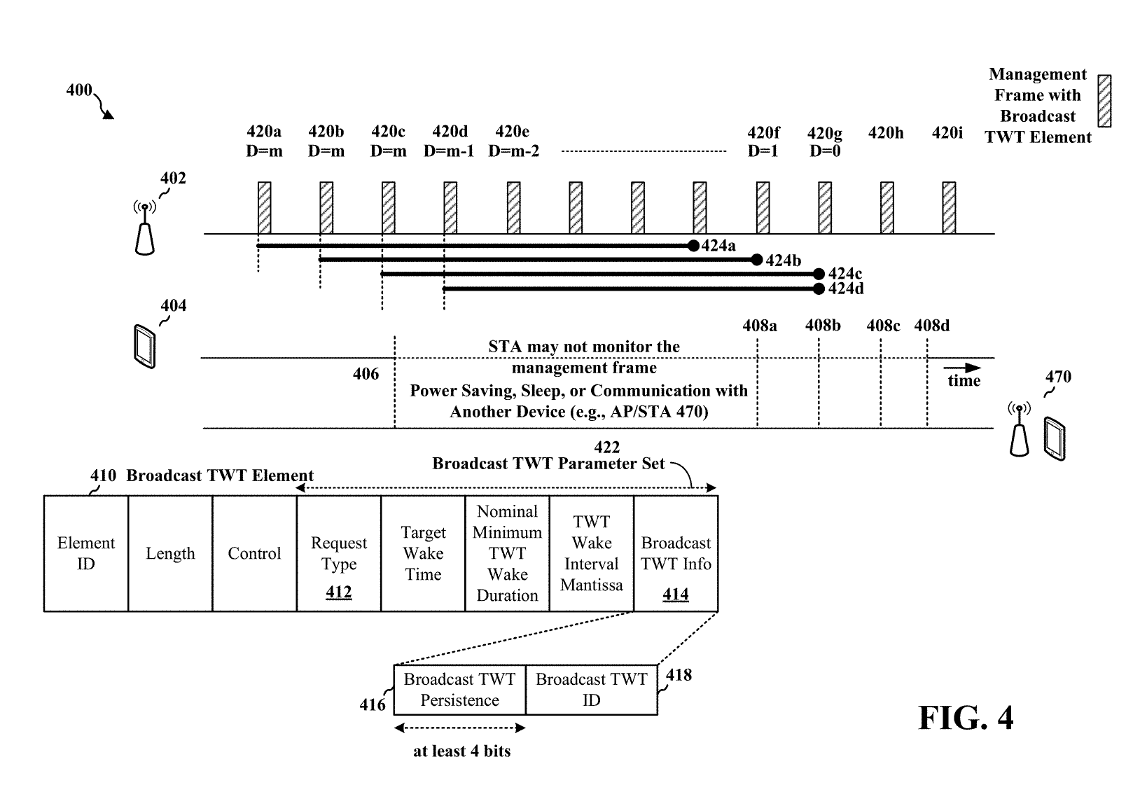

FIG. 4 shows a first diagram 400 illustrating exemplary communication between an AP 402 and a STA 404. As shown in FIG. 4, an AP 402 broadcasts management frames 420a-420i, which are received by a STA 404. The management frames 420a-420i include a broadcast TWT element 410. The broadcast TWT element 410 includes several fields, including an element ID, a length, a control field, and a broadcast TWT parameter set 422. The broadcast TWT parameter set 422 includes a request type field 412, a target wake time, a nominal minimum TWT wake duration, a TWT wake interval mantissa, and a broadcast TWT info field 414. The broadcast TWT info field 414 includes a broadcast TWT persistence subfield 416 and a broadcast TWT ID 418. In a first configuration, the broadcast TWT persistence subfield 416 is at least four bits. In a second configuration, the broadcast TWT persistence subfield 416 is at least eight bits. In both the first and second configurations, the broadcast TWT persistence subfield 416 indicates a guaranteed validity of the broadcast TWT parameter set 422 associated with the broadcast TWT schedule identified by the broadcast TWT ID 418. The validity of the broadcast TWT parameter set 422 is a time duration D in which the AP 402 specifies that the broadcast TWT parameter set 422 is valid. The time duration D may be a number of intervals (e.g., beacon intervals, or DTIM intervals) for which the broadcast TWT parameter set 422 is valid. Specifically, the number of intervals may be a number of TBTTs of a beacon or a number of beacons that include a DTIM. In a first configuration, the number of intervals may be indicated by a linear function that represents up to 2^{N} intervals, where N is the number of bits of the broadcast TWT persistence subfield 416 (e.g., if N=4 (i.e., the broadcast TWT persistence subfield 416 has 4 bits), then the broadcast TWT persistence subfield 416 can indicate up to 15 intervals, and if N=8 (i.e., the broadcast TWT persistence subfield 416 has 8 bits), then the broadcast TWT persistence subfield 416 can indicate up to 255 intervals). In a second configuration, the number of intervals may be indicated by an exponential function of X^{D}, where D is indicated by the broadcast TWT persistence subfield 416 (e.g., for X=2 and D=15, 2¹⁵ intervals can be indicated). The number of intervals may be indicated by other functions, such as for example, a function with both linear and non-linear components.

In each subsequently transmitted broadcast TWT element 410, the AP 402 may maintain the broadcast TWT persistence subfield 416 at the same value, decrement the value of the broadcast TWT persistence subfield 416 by one (e.g., when the number of intervals is indicated by a linear function), or before fully decrementing the value of the broadcast TWT persistence subfield 416 to zero, increase the value of the broadcast TWT persistence subfield 416 by any amount allowed by the broadcast TWT persistence subfield 416. Accordingly, the STA 404, having received the broadcast TWT element 410 including the broadcast TWT persistence subfield 416 can determine that the broadcast TWT schedule associated with the broadcast TWT ID 418 will be valid at least as long as the time duration D specified in the broadcast TWT persistence subfield 416.

An example is provided in FIG. 4. As illustrated in FIG. 4, the AP 402 transmits a management frame 420a with a broadcast TWT element 410 including a broadcast TWT persistence subfield 416 with integer value m. The STA 404 receives the management frame 420a with the broadcast TWT element 410 and determines that the broadcast TWT parameter set 422 associated with the broadcast TWT ID 418 within the broadcast TWT element 410 will be valid for at least as long as the guaranteed validity window 424a specified by the value m (e.g., m intervals, m beacon intervals, m DTIM intervals, or the like). Subsequently, the AP 402 transmits a management frame 420b with a broadcast TWT element 410 including a broadcast TWT persistence subfield 416 again with integer value m. The STA 404 receives the management frame 420b with the broadcast TWT element 410 and determines that the broadcast TWT parameter set 422 associated with the broadcast TWT ID 418 within the broadcast TWT element 410 will be valid for at least as long as the guaranteed validity window 424b specified by the value m. Subsequently, the AP 402 transmits a management frame 420c with a broadcast TWT element 410 including a broadcast TWT persistence subfield 416 again with integer value m. The STA 404 receives the management frame 420c with the broadcast TWT element 410 and determines that the broadcast TWT parameter set 422 associated with the broadcast TWT ID 418 within the broadcast TWT element 410 will be valid for at least as long as the guaranteed validity window 424c specified by the value m. At this time point or before this time point, the AP 402 determines to change the broadcast TWT parameter set 422 associated with the broadcast TWT ID 418. Consequently, the AP 402 decrements by one the broadcast TWT persistence subfield 416 in the broadcast TWT element 410 of the management frame 420d. The STA 404 receives the management frame 420d with the broadcast TWT element 410 and determines that the broadcast TWT parameter set 422 associated with the broadcast TWT ID 418 within the broadcast TWT element 410 will be valid for at least as long as the guaranteed validity window 424d specified by the value m−1. The AP 402 continues to decrement by one the broadcast TWT persistence subfield 416 in the broadcast TWT elements 410 of the management frames 420e, . . . , 420f, 420g. After 420g, the broadcast TWT parameter set 422 has expired, and a new broadcast TWT parameter set is transmitted in the broadcast TWT elements 410 of the management frames 420h, 420i.

As illustrated in FIG. 4, based on the value of the broadcast TWT persistence subfield 416 in the broadcast TWT element 410 of the management frame 420c, the STA 404 may determine at 406 to enter into a sleep/power saving mode or otherwise not to monitor for subsequent management frames for a certain time duration. When not monitoring management frames, the STA 404 skips broadcast TWT SPs. If the STA 404 determines to refrain from monitoring for subsequent management frames from the AP 402, the STA 404 may determine to terminate/stop any ongoing processing/decoding of management frames in its receive buffer. Accordingly, the STA 404 may refrain from processing a portion of or an entire subsequent management frame upon determining to refrain from monitoring subsequent management frames. If the management frames transmitted by the AP 402 are beacon frames, the refraining by the STA 404 from processing a portion of or an entire subsequent beacon frame may be referred to as early beacon termination.

The STA 404 may determine the time duration in which to skip broadcast TWT SPs (e.g., sleeping, power savings, monitoring/communicating with other networks/devices 470) based on when the AP 402 provides the new broadcast TWT parameter set. The AP 402 may provide the new broadcast TWT parameter set as soon as the AP 402 determines to change the broadcast TWT parameter set 422 (e.g., at 420c or 420d), or sometime before the AP 402 changes the broadcast TWT parameter set 422 (e.g., at 420g, 420f, or earlier). If the AP 402 provides the new broadcast TWT parameter set right before the AP 402 changes the broadcast TWT parameter set 422, the STA 404 may return to monitor for the new broadcast TWT parameter set at 408a or 408b, for example. If the AP 402 provides the new broadcast TWT parameter set earlier, such as at 420c or 420d, the STA 404 may return to monitor the new broadcast TWT schedule right before the new broadcast TWT schedule starts, such as at 408c, or after the new broadcast TWT schedule has started, such as at 408d. Accordingly, the broadcast TWT persistence subfield 416, being at least four bits and representing a validity of the broadcast TWT parameter set 422, provides the STA 404 with requisite notice of broadcast TWT parameter set changes so that the STA 404 can sleep longer, save more power/energy, and/or spend more time monitoring other networks/devices (e.g., 470) or communicating with APs (e.g., 470) other than the AP 402.

FIG. 5 shows a diagram 500 illustrating an exemplary broadcast TWT element 510 with multiple broadcast TWT parameter sets 522a, 522b. The broadcast TWT element 510 includes an element ID, a length, a control field, and TWT parameter information. The TWT parameter information includes at least one broadcast TWT parameter set. When the AP 402 determines to change the broadcast TWT parameter set 422 for a broadcast TWT schedule, the AP 402 may include at least two broadcast TWT parameters sets 522a, 522b associated with the same broadcast TWT ID 518 within the TWT parameter information of the broadcast TWT element 510. Each broadcast TWT parameter set 522a, 522b includes a request type field 512, 530, respectively, and a broadcast TWT info field 514, 532, respectively. The broadcast TWT parameter sets 522a, 522b, when associated with the same broadcast TWT ID 518, may have their request type fields 512 set to different values. Possible values of the request type field 512 include request TWT, suggest TWT, demand TWT, TWT grouping, accept TWT, alternate TWT, dictate TWT, and reject TWT. Of the possible request type field 512 values, the AP 402 may only use the accept TWT, alternate TWT, dictate TWT, and reject TWT values. The request type field 512 of alternate TWT indicates that one or more parameters in the broadcast TWT parameter set will change subsequent to expiration of the broadcast TWT schedule. The request type field 512 of accept TWT indicates a new broadcast TWT parameter set that will be applicable subsequent to expiration of the broadcast TWT schedule. In one configuration, in order to indicate to the STA 404 that the broadcast TWT parameter set 422 is changing, the AP 402 includes within the broadcast TWT element 510 the broadcast TWT parameter set 522a, which is the same as the broadcast TWT parameter set 422 with the validity time duration specified in the broadcast TWT persistence subfield 516, but with the request type field 512 set to alternate TWT, and includes within the broadcast TWT element 510 the broadcast TWT parameter set 522b, which is the new broadcast TWT parameter set and has the request type field 512 set to accept TWT. When the STA 404 receives the broadcast TWT parameter sets 522a, 522b, the STA 404 is able to determine from the broadcast TWT parameter set 522a that an alternate broadcast TWT parameter set is being provided, and from the broadcast TWT parameter set 522b, the new broadcast TWT parameter set for the broadcast TWT schedule that will follow the current broadcast TWT schedule upon termination of the current broadcast TWT schedule.

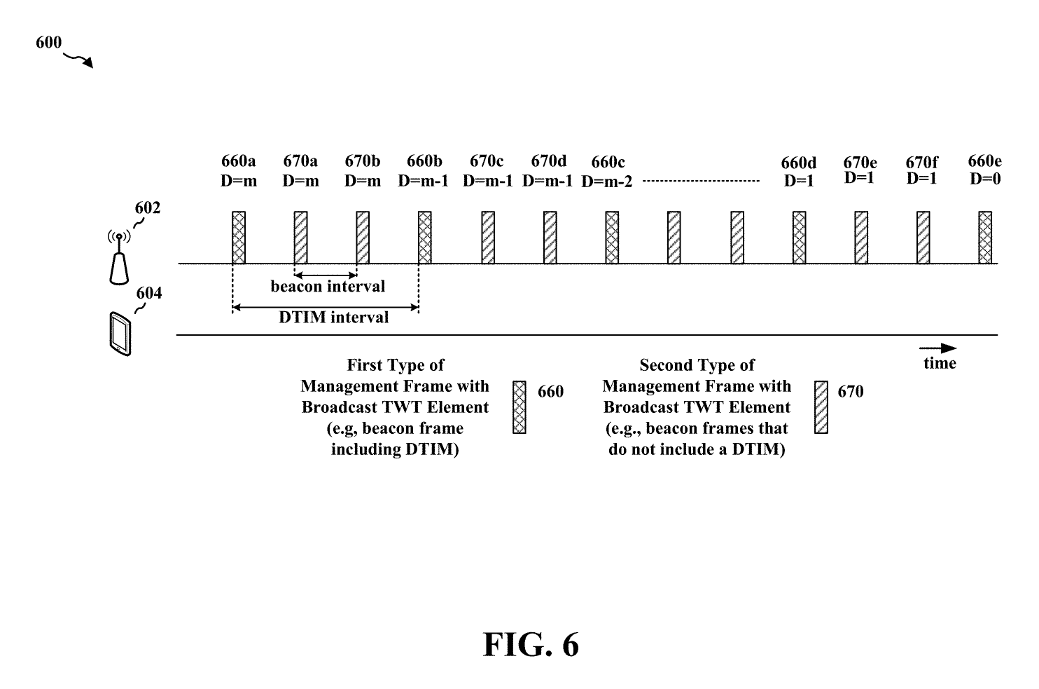

FIG. 6 shows a second diagram 600 illustrating exemplary communication between an AP 602 and a STA 604. As shown in FIG. 6, the AP 602 transmits first and second types of management frames 660, 670, respectively. Both the first and second types of management frames 660, 670 may include a broadcast TWT element 410/510. However, in one configuration, the AP 602 adjusts (i.e., decrements or otherwise changes) the broadcast TWT persistence subfield 416/516 only in the first type of management frame 660, and maintains the current broadcast TWT persistence value in the broadcast TWT persistence subfield 416/516 in the second type of management frame 670. An example is provided in FIG. 6. As illustrated in FIG. 6, the AP 602 transmits to the STA 604 the management frame 660a, which is a first type of management frame 660. The management frame 660a includes a broadcast TWT element 410/510 with the broadcast TWT persistence subfield 416/516 set to D=m. Subsequently, the AP 602 transmits to the STA 604 the management frames 670a, 670b, both of which are a second type of management frame 670. The management frames 670a, 670b include broadcast TWT elements 410/510 with the broadcast TWT persistence subfield 416/516 set to the same value D=m as in the previously transmitted first type of management frame 660a. Subsequently, the AP 602 transmits to the STA 604 the management frame 660b, which is a first type of management frame 660. The management frame 660b includes a broadcast TWT element 410/510 with the broadcast TWT persistence subfield 416/516 set to D=m−1. Accordingly, the AP 602 has determined that the validity of the current broadcast TWT parameter set will expire after the time duration m−1. Subsequently, the AP 602 transmits to the STA 604 the management frames 670c, 670d, both of which are a second type of management frame 670. The management frames 670c, 670d include broadcast TWT elements 410/510 with the broadcast TWT persistence subfield 416/516 set to the same value D=m−1 as in the previously transmitted first type of management frame 660b. Subsequently, the AP 602 transmits to the STA 604 the management frame 660c, which is a first type of management frame 660. The management frame 660b includes a broadcast TWT element 410/510 with the broadcast TWT persistence subfield 416/516 set to D=m−2. The AP 602 continues transmitting the first and second types of management frames 660, 670. Then, the AP 602 transmits to the STA 604 the management frame 660d, which is a first type of management frame 660. The management frame 660d includes a broadcast TWT element 410/510 with the broadcast TWT persistence subfield 416/516 set to D=1. Subsequently, the AP 602 transmits to the STA 604 the management frames 670e, 670f, both of which are a second type of management frame 670. The management frames 670e, 670f include broadcast TWT elements 410/510 with the broadcast TWT persistence subfield 416/516 set to the same value D=1 as in the previously transmitted first type of management frame 660d. Subsequently, the AP 602 transmits to the STA 604 the management frame 660e, which is a first type of management frame 660. The management frame 660e includes a broadcast TWT element 410/510 with the broadcast TWT persistence subfield 416/516 set to D=0. Accordingly, the current broadcast TWT schedule from the AP 602 has expired.

In a first configuration, the first management frame 660 is a beacon frame, and the second management frame 670 is one of a probe response frame, a broadcast probe response frame, an association response frame, a re-association response frame, or a FILS discovery frame. In a second configuration, the first management frame 660 is a beacon frame that includes a DTIM (which may be referred to as a DTIM beacon frame), and the second management frame 670 is one of a probe response frame, a broadcast probe response frame, an association response frame, a re-association response frame, a FILS discovery frame, or a beacon frame that does not include a DTIM (which may be referred to as a non-DTIM beacon frame). In a third configuration (or a sub-configuration of the second configuration), the first management frame 660 is a DTIM beacon frame and the second management frame 670 is a non-DTIM beacon frame. Accordingly, in the third configuration, both the first and second types of management frames 660, 670 that include a broadcast TWT element are beacon frames. The DTIM beacon frames may be transmitted with a periodicity equal to a DTIM interval. FIG. 6 illustrates a DTIM beacon frame being transmitted with a periodicity/DTIM interval of once every three beacon frames. The non-DTIM beacon frames may be transmitted with a periodicity equal to a beacon interval. In one example, the beacon interval is once every 100 ms.

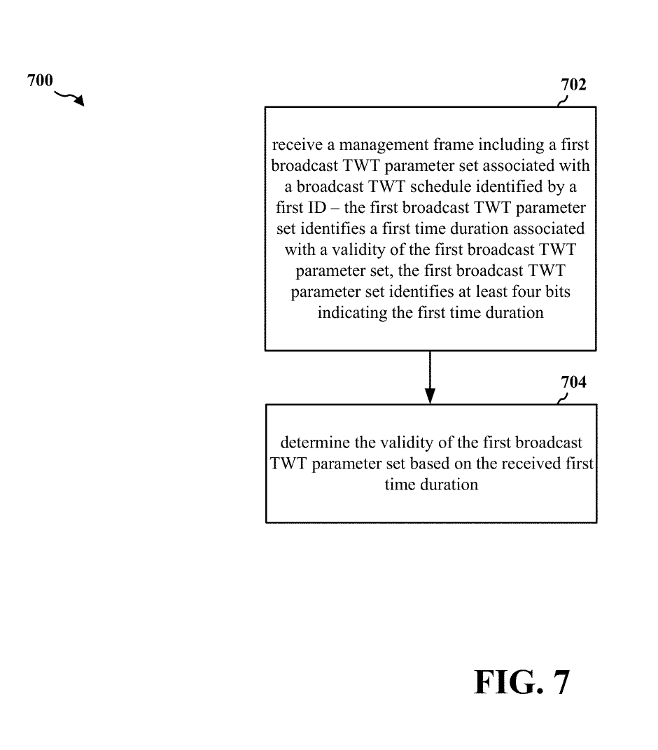

FIG. 7 shows a flowchart 700 illustrating a first example process for a STA according to some implementations. The first example process may be performed by a wireless communication device at the STA, such as for example, the processor 310. Herein, the wireless communication device at the STA may be referred to generally as a STA. At 702, the STA receives a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. For example, referring to FIG. 4, the STA 404 receives management frames (one or more of the management frames 420a-420g) from the AP 402. Each of the management frames 420a-420g includes a first broadcast TWT parameter set 422 associated with a broadcast TWT schedule identified by a first ID 418. The first broadcast TWT parameter set 422 identifies a first time duration D associated with a validity of the first broadcast TWT parameter set 422. The first broadcast TWT parameter set 422 identifies at least four bits (see 416) within the broadcast TWT persistence subfield 416 indicating the first time duration D. At 704, the STA determines the validity of the first broadcast TWT parameter set based on the received first time duration. For example, referring to FIG. 4, the STA 404 may determine validity windows 424a, 424b, 424c, 424d of the first broadcast TWT parameter set 422 based on the received first time duration D in the broadcast TWT persistence subfield 416. The STA 404 determines the time length of the validity windows 424a-424d based on the validity windows 424a-424d extending until the first time duration D is equal to zero, assuming that the first time duration D will decrease by one in each received management frame with a broadcast TWT element 410. Upon determining the validity of the first broadcast TWT parameter set 422, the STA 404 may determine whether or not to monitor subsequent management frames (see 406, 408a-408d of FIG. 4, and related discussion above).

Referring to FIG. 4, the first time duration D may indicate a number of intervals for which the first broadcast TWT parameter set 422 is guaranteed to be valid. The number of intervals corresponds to a guaranteed validity window for the first broadcast TWT parameter set 422. For example, the management frame 420c includes a broadcast TWT persistence subfield 416 that may indicate m number of management frame transmission intervals during the validity window 424c for which the first broadcast TWT parameter set 422 is guaranteed to be valid. For another example, the management frame 420d includes a broadcast TWT persistence subfield 416 that may indicate m−1 number of management frame transmission intervals during the validity window 424d for which the first broadcast TWT parameter set 422 is guaranteed to be valid. Referring to FIG. 6, each interval of the intervals may be a beacon interval corresponding to a beacon frame, or may be a DTIM interval corresponding to a beacon frame that includes a DTIM. The number of intervals may be a number of beacon frames transmissions before expiration of the first broadcast TWT parameter set 422 (which may be referred to as TBTTs of a beacon), or may be a number of beacon frame transmissions that include a DTIM before expiration of the first broadcast TWT parameter set 422. The at least four bits may identify a value that indicates the number of intervals. The value may represent an integer number that is based on a linear function that represents up to 2^{N} intervals, where N is a number of bits of the at least four bits identifying the determined time duration and N is greater than or equal to four. For example, the broadcast TWT persistence subfield 416 may have N bits, where N is greater than or equal to four, and the N bits may represent up to 2^{N} intervals. In one example, if N is equal to 4 bits, then the 4 bits may indicate up to 15 intervals. In one example, if N is equal to 8 bits, then the 8 bits may indicate up to 255 intervals.

At 702, the management frame may be one of a probe response frame, a broadcast probe response frame, an association response frame, a re-association response frame, a FILS discovery frame, a beacon frame with a periodicity of a beacon interval, or a beacon frame that includes a DTIM with a periodicity of a DTIM interval. Referring to FIG. 5, the management frame at 702 may include the first broadcast TWT parameter set 522a identified by the first ID 518 and a second broadcast TWT parameter set 522b also identified by the first ID 518. The first broadcast TWT parameter set 522a may include a request type field 512 indicating an alternate TWT. The second broadcast TWT parameter set 522b may include a second request type subfield 522b indicating an accept TWT. The request type field 512 indicating alternate TWT may indicate that one or more parameters in the first broadcast TWT parameter set 522a will change subsequent to expiration of the determined first time duration in the broadcast TWT persistence subfield 516. The request type field 530 indicating accept TWT may indicate a new parameter set in the second broadcast TWT parameter set 522b that is applicable subsequent to expiration of the determined first time duration in the broadcast TWT persistence subfield 516.

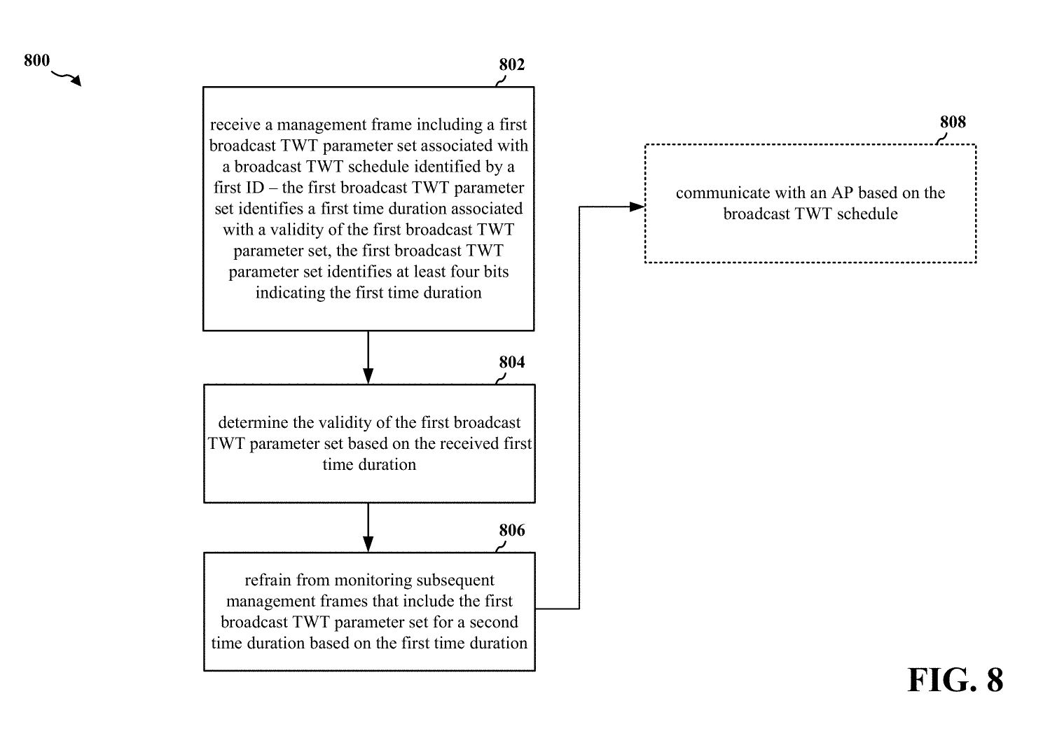

FIG. 8 shows a flowchart 800 illustrating a second example process for a STA according to some implementations. The second example process may be performed by a wireless communication device at the STA, such as for example, the processor 310. At 802, the STA receives a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. For example, referring to FIG. 4, the STA 404 receives management frames (one or more of the management frames 420a-420g) from the AP 402. Each of the management frames 420a-420g includes a first broadcast TWT parameter set 422 associated with a broadcast TWT schedule identified by a first ID 418. The first broadcast TWT parameter set 422 identifies a first time duration D associated with a validity of the first broadcast TWT parameter set 422. The first broadcast TWT parameter set 422 identifies at least four bits (see 416) within the broadcast TWT persistence subfield 416 indicating the first time duration D. At 804, the STA determines the validity of the first broadcast TWT parameter set based on the received first time duration. For example, referring to FIG. 4, the STA 404 may determine validity windows 424a-424d of the first broadcast TWT parameter set 422 based on the received first time duration D in the broadcast TWT persistence subfield 416. The STA 404 determines the time length of the validity windows 424a-424d based on the validity windows 424a-424d extending until the first time duration D is equal to zero, assuming that the first time duration D will decrease by one in each received management frame with a broadcast TWT element. Upon determining the validity of the first broadcast TWT parameter set 422, the STA 404 may determine whether or not to monitor subsequent management frames (see 406, 408a-408d of FIG. 4, and related discussion above).

At 806, the STA refrains from monitoring subsequent management frames that include the first broadcast TWT parameter set for a second time duration based on the first time duration. For example, referring to FIG. 4, based on the first time duration D=m received in the management frame 420c (which indicates a guaranteed validity through the validity window 424c), the STA 404 may refrain from monitoring one or more of the subsequent management frames 420d-420g that include the first broadcast TWT parameter set 422 for a second time duration between 406 and 408a, between 406 and 408b, between 406 and 408c, between 406 and 408d, or some other time duration. The STA 404 may base the length of the second time duration and/or when the second time duration occurs on whether the STA 404 has determined the new broadcast TWT parameter set that will replace the first broadcast TWT parameter set 422 upon expiration of the first time duration (i.e., after the end of the validity window 424c) and/or when the information indicating the new broadcast TWT parameter set may be received from the AP 402.

At 806, when the STA 404 refrains from monitoring subsequent management frames (one or more of the management frames 420d-420g), the STA 404 may enter into a power saving mode for the second time duration, as discussed in relation to FIG. 4. When entering into the power saving mode, the STA 404 may enter into a sleep state in order to skip broadcast TWT SPs. The STA 404 may enter the sleep state for the second time duration. The second time duration may be less than, equal to, or greater than the first time duration. For example, referring to FIG. 4, the second time duration may be between 406 and 408a, which is less than the first time duration. For another example, the second time duration may be between 406 and 408b, which is slightly less or almost equal to the first time duration. For another example, the second time duration may be between 406 and 408c or between 406 and 408d, which is equal to or greater than the first time duration.

At 802, the management frame may be received from an AP 402, as illustrated in FIG. 4. Further, at 806, instead of monitoring/receiving the subsequent management frames transmitted by the AP 402, the STA 404 may monitor signals from a device 470 other than the AP 402 or may communicate with a device 470 other than the AP 402. In such a configuration, the STA 404 may monitor signals from the device 470 and/or communicate with the device 470 for the second time duration concurrently while the AP 402 transmits the subsequent management frames.

At 806, when the STA 404 refrains from monitoring the subsequent management frames from the AP 402, the STA 404 may refrain from processing a portion of or an entire subsequent management frame, as discussed above. Accordingly, when the STA 404 determines to refrain from monitoring subsequent management frames from the AP 402, the STA 404 may terminate/stop any ongoing processing/decoding of management frames in its receive buffer (referred to as early beacon termination when the management frames are beacon frames).

At 808, the STA 404 may communicate with the AP 402 based on the broadcast TWT schedule. At 808, the STA 404 may receive DL MU PPDUs from the AP 402 during a listen interval corresponding to the broadcast TWT schedule.

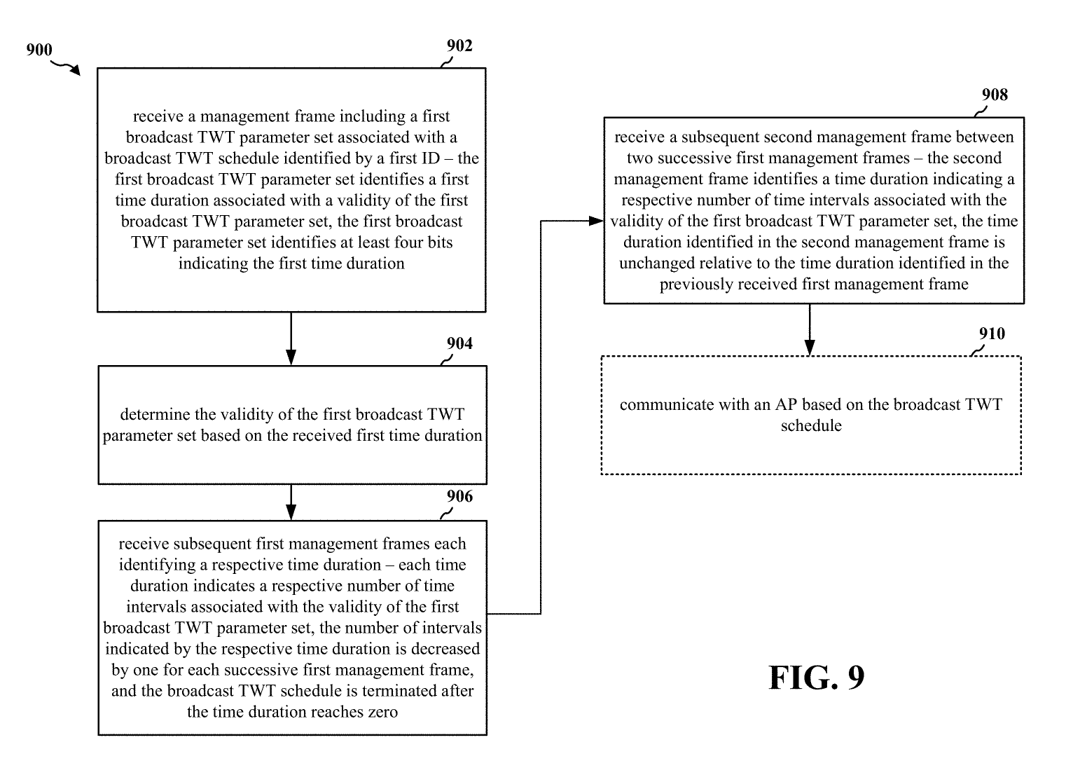

FIG. 9 shows a flowchart 900 illustrating a third example process for a STA according to some implementations. The third example process may be performed by a wireless communication device at the STA, such as for example, the processor 310. At 902, the STA receives a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. For example, referring to FIG. 4, the STA 404 receives management frames (one or more of the management frames 420a-420g) from the AP 402. Each of the management frames 420a-420g includes a first broadcast TWT parameter set 422 associated with a broadcast TWT schedule identified by a first ID 418. The first broadcast TWT parameter set 422 identifies a first time duration D associated with a validity of the first broadcast TWT parameter set 422. The first broadcast TWT parameter set 422 identifies at least four bits (see 416) within the broadcast TWT persistence subfield 416 indicating the first time duration D. At 904, the STA determines the validity of the first broadcast TWT parameter set based on the received first time duration. For example, referring to FIG. 4, the STA 404 may determine validity windows 424a-424d of the first broadcast TWT parameter set 422 based on the received first time duration D in the broadcast TWT persistence subfield 416. The STA 404 determines the time length of the validity windows 424a-424d based on the validity windows 424a-424d extending until the first time duration D is equal to zero, assuming that the first time duration D will decrease by one in each received management frame with a broadcast TWT element. Upon determining the validity of the first broadcast TWT parameter set 422, the STA 404 may determine whether or not to monitor subsequent management frames (see 406, 408a-408d of FIG. 4, and related discussion above).

Referring to FIGS. 6 and 9, the received management frame may be the management frame 660a. At 906, the STA 604 may receive subsequent first management frames 660b, 660c each identifying a respective time duration (e.g. D=m−1, D=m−2, respectively). Each time duration indicates a respective number of time intervals associated with the validity of the first broadcast TWT parameter set 422. As illustrated in FIGS. 4, 6, the number of intervals indicated by the respective time duration (i.e., the value in the broadcast TWT persistence subfield 416) decreases by one for each successive first management frame 660b, 660c. The broadcast TWT schedule terminates after the time duration reaches zero (in FIG. 6, after receiving the first type of management frame 660e). At 908, the STA 604, receives a subsequent second management frame 670c or 670d between the two successive first management frames 660b, 660c. The second management frame 670c/670d identifies a time duration D=m−1 indicating a respective number of time intervals associated with the validity of the first broadcast TWT parameter set 422. The time duration D=m−1 identified in the second management frame 670c/670d is unchanged relative to the time duration D=m−1 identified in the previously received first management frame 660b.

In a first configuration, each of the first management frames 660 may be a beacon frame, and the second management frames 670 may be one or more of a probe response frame, a broadcast probe response frame, an association response frame, a re-association response frame, or a FILS discovery frame. In a second configuration, each of the first management frames 660 is a beacon frame that includes a DTIM, and the second management frames 670 may be one or more of a probe response frame, a broadcast probe response frame, an association response frame, a re-association response frame, a FILS discovery frame, or a beacon frame that does not include a DTIM (i.e., a non-DTIM beacon frame).

At 910, the STA 404 may communicate with the AP 402 based on the broadcast TWT schedule. At 910, the STA 404 may receive DL MU PPDUs from the AP 402 during a listen interval corresponding to the broadcast TWT schedule.

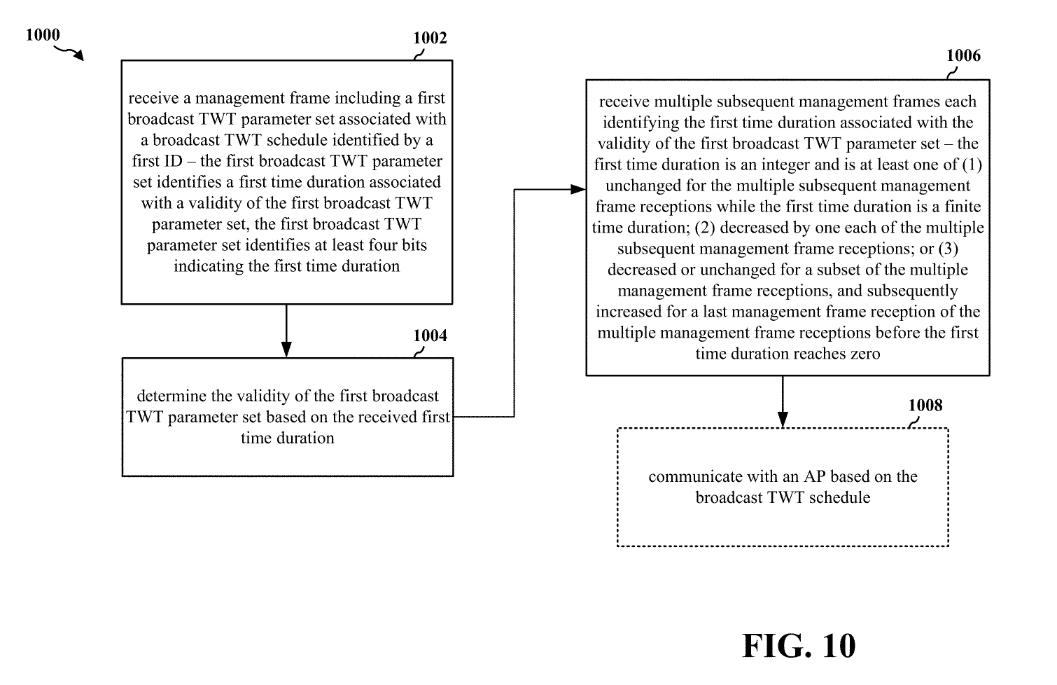

FIG. 10 shows a flowchart 1000 illustrating a fourth example process for a STA according to some implementations. The fourth example process may be performed by a wireless communication device at the STA, such as for example, the processor 310. At 1002, the STA receives a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. For example, referring to FIG. 4, the STA 404 receives management frames (one or more of the management frames 420a-420g) from the AP 402. Each of the management frames 420a-420g includes a first broadcast TWT parameter set 422 associated with a broadcast TWT schedule identified by a first ID 418. The first broadcast TWT parameter set 422 identifies a first time duration D associated with a validity of the first broadcast TWT parameter set 422. The first broadcast TWT parameter set 422 identifies at least four bits (see 416) within the broadcast TWT persistence subfield 416 indicating the first time duration D. At 1004, the STA determines the validity of the first broadcast TWT parameter set based on the received first time duration. For example, referring to FIG. 4, the STA 404 may determine validity windows 424a-424d of the first broadcast TWT parameter set 422 based on the received first time duration D in the broadcast TWT persistence subfield 416. The STA 404 may determine the time length of the validity windows 424a-424d based on the validity windows 424a-424d extending until the first time duration D is equal to zero, assuming that the first time duration D will decrease by one in each received management frame with a broadcast TWT element. Upon determining the validity of the first broadcast TWT parameter set 422, the STA 404 may determine whether or not to monitor subsequent management frames (see 406, 408a-408d of FIG. 4, and related discussion above).

Referring to both FIGS. 4, 10, assume the management frame received at 1002 is the management frame 420a. At 1006, the STA 404 receives multiple subsequent management frames 420b-420g, each identifying the first time duration D associated with the validity (see guaranteed validity windows 424a-424d) of the first broadcast TWT parameter set 422. As discussed above, the first time duration D may be an integer and may be at least one of (1) unchanged for the multiple subsequent management frame receptions (e.g., 420b are 420c have a first time duration D that is unchanged with respect to 420a) while the first time duration D is a finite time duration (i.e., the first time duration D within 420b, 420c correspond to finite guaranteed validity windows 424b, 424c, respectively); (2) decreased by one each of the multiple subsequent management frame receptions (e.g., 420d, 420e, . . . , 420f, 420g each have a first time duration D that is decreased by one); or (3) decreased or unchanged for a subset of the multiple management frame receptions, and subsequently increased for a last management frame reception of the multiple management frame receptions before the first time duration reaches zero. With respect to (3), the first time duration D may be increased at any time before the reception of the management frame 420g in which the first time duration D is equal to 0. When the first time duration D decreases by one each management frame reception, the guaranteed validity window shortens each management frame reception. However, when the first time duration is increased before the first time duration D is equal to 0, the guaranteed validity window is lengthened relative to a previous guaranteed validity window.

At 1008, the STA 404 may communicate with the AP 402 based on the broadcast TWT schedule. At 1008, the STA 404 may receive DL MU PPDUs from the AP 402 during a listen interval corresponding to the broadcast TWT schedule.

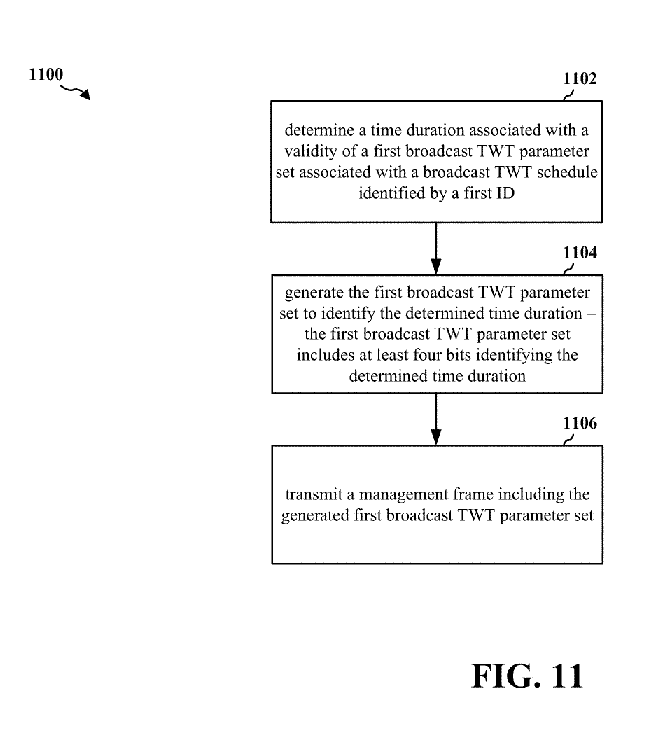

FIG. 11 shows a flowchart 1100 illustrating a first example process for an AP according to some implementations. The first example process may be performed by a wireless communication device at the AP, such as for example, the processor 210. Herein, the wireless communication device at the AP may be referred to generally as an AP. At 1102, the AP determines a time duration associated with a validity of a first broadcast TWT parameter set associated with a broadcast TWT schedule identified by a first ID. For example, referring to FIG. 4, the AP 402 determines a time duration D associated with a validity (see validity windows 424a, 424b, 424c, 424d) of a first broadcast TWT parameter set 422 associated with a broadcast TWT schedule identified by a first ID 418. At 1104, the AP generates the first broadcast TWT parameter set to identify the determined time duration. The first broadcast TWT parameter set includes at least four bits identifying the determined time duration. For example, referring to FIG. 4, the AP 402 generates the first broadcast TWT parameter set 422 to identify the determined time duration D within the broadcast TWT persistence subfield 416. The first broadcast TWT parameter set 422 includes the broadcast TWT persistence subfield 416, which is at least four bits that identify the determined time duration D. At 1106, the AP transmits a management frame including the generated first broadcast TWT parameter set. For example, referring to FIG. 4, the AP 402 transmits management frames 420a-420g including the generated first broadcast TWT parameter set 422. The time duration D may indicate a number of intervals for which the first broadcast TWT parameter set 422 is guaranteed to be valid.

Referring to FIGS. 4, 6, in a first configuration, each interval of the intervals may be a beacon interval corresponding to a beacon frame. In such a configuration, the beacon frame may or may not include a DTIM. In a second configuration, each interval of the intervals may be a DTIM interval corresponding to a beacon frame that includes a DTIM. The number of intervals may be a number of beacons, which may be referred to as a number of TBTTs of a beacon, or may be a number of beacons including a DTIM. The at least four bits with the broadcast TWT persistence subfield 416 identify a value D that indicates the number of intervals. In one configuration, the value D represents an integer number that is based on a linear function that represents up to 2^{N} intervals, where N is a number of bits of the at least four bits identifying the determined time duration, and N is greater than or equal to four.

The management frames 420a-420i, 670a-670e may be one or more of a probe response frame, a broadcast probe response frame, an association response frame, a re-association response frame, a FILS discovery frame, a beacon frame with a periodicity of a beacon interval, or a beacon frame with a periodicity of a DTIM interval.

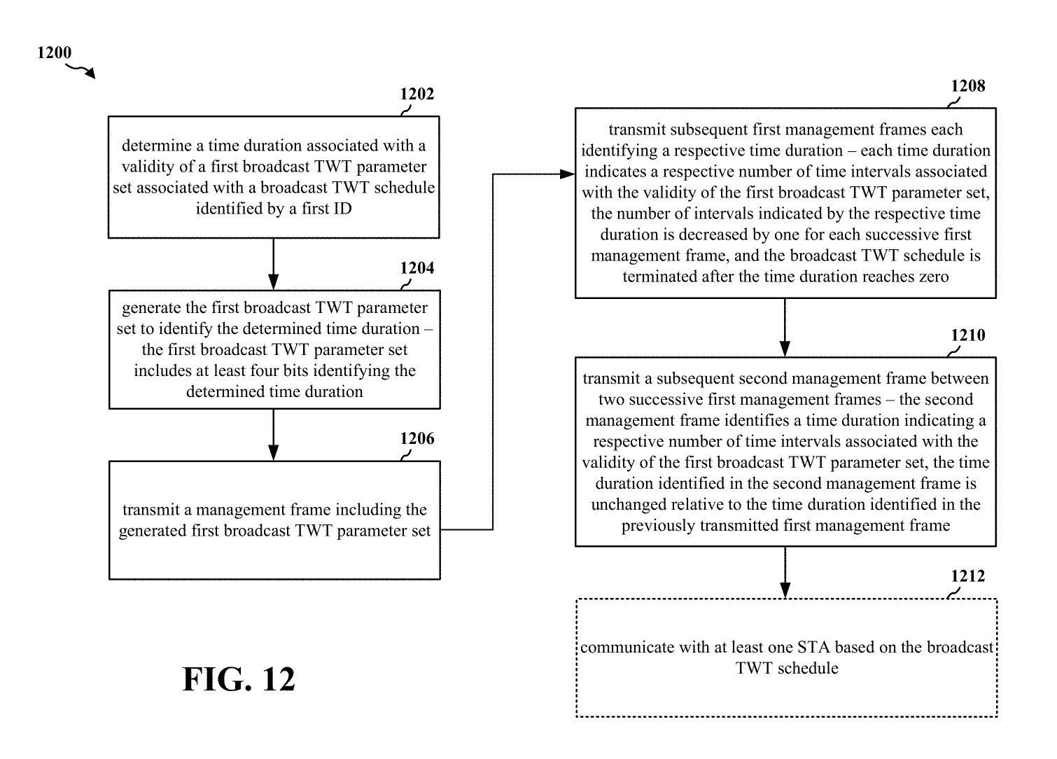

FIG. 12 shows a flowchart 1200 illustrating a second example process for an AP according to some implementations. The second example process may be performed by a wireless communication device at the AP, such as for example, the processor 210. At 1202, the AP determines a time duration associated with a validity of a first broadcast TWT parameter set associated with a broadcast TWT schedule identified by a first ID. For example, referring to FIG. 4, the AP 402 determines a time duration D associated with a validity (see validity windows 424a, 424b, 424c, 424d) of a first broadcast TWT parameter set 422 associated with a broadcast TWT schedule identified by a first ID 418. At 1204, the AP generates the first broadcast TWT parameter set to identify the determined time duration. The first broadcast TWT parameter set includes at least four bits identifying the determined time duration. For example, referring to FIG. 4, the AP 402 generates the first broadcast TWT parameter set 422 to identify the determined time duration D within the broadcast TWT persistence subfield 416. The first broadcast TWT parameter set 422 includes the broadcast TWT persistence subfield 416, which is at least four bits that identify the determined time duration D. At 1206, the AP transmits a management frame including the generated first broadcast TWT parameter set. For example, referring to FIG. 4, the AP 402 transmits management frame 420a-420g including the generated first broadcast TWT parameter set 422. The time duration D may indicate a number of intervals for which the first broadcast TWT parameter set 422 is guaranteed to be valid.

Referring to FIGS. 4, 6, 12, at 1208, the AP 402 may transmit subsequent first management frames 660 each identifying a respective time duration D. For example, the AP 402 transmits the first management frames 660a, 660b, 660c, 660d, and 660e with the time durations D=m, D=m−1, D=m−2, D=1, and D=0, respectively. As illustrated in the example, each time duration D indicates a respective number of time intervals associated with the validity of the first broadcast TWT parameter set 422. The number of intervals indicated by the respective time duration D is decreased by one for each successive first management frame. The broadcast TWT schedule is terminated after the time duration D reaches zero.

At 1210, the AP 402 transmits a subsequent second management frame (e.g., any one of 670a, 670b, 670c, 670d, 670e, 670f) between two successive first management frames. For example, the AP 402 transmits the subsequent second management frames 670a/670b between the two successive first management frames 660a, 660b. For another example, the AP 402 transmits the subsequent second management frames 670c/670d between the two successive first management frames 660b, 660c. For yet another example, the AP 402 transmits the subsequent second management frames 670e/670f between the two successive first management frames 660d, 660e. Like the first management frames 660, the second management frames 670 also identify a time duration D indicating a respective number of time intervals associated with the validity of the first broadcast TWT parameter set 422. However, the time duration D identified in the second management frames are unchanged relative to the time duration D identified in the previously transmitted first management frame. For example, the time duration D=m identified in the second management frames 670a, 670b are unchanged relative to the time duration D=m identified in the previously transmitted first management frame 660a. For another example, the time duration D=m−1 identified in the second management frames 670c, 670d are unchanged relative to the time duration D=m−1 identified in the previously transmitted first management frame 660b. For yet another example, the time duration D=1 identified in the second management frames 670e, 670f are unchanged relative to the time duration D=1 identified in the previously transmitted first management frame 660d.

In a first configuration, each of the first management frames 660 is a beacon frame, and the second management frames 670 are one or more of a probe response frame, a broadcast probe response frame, an association response frame, a re-association response frame, or a FILS discovery frame. In a second configuration, each of the first management frames 660 is a beacon frame that includes a DTIM, and the second management frames 670 are one or more of a probe response frame, a broadcast probe response frame, an association response frame, a re-association response frame, a FILS discovery frame, or a beacon frame that does not include a DTIM.

At 1212, the AP 402 may communicate with at least one STA based on the broadcast TWT schedule. At 1212, the AP 402 may transmit DL MU PPDUs to the STA 404 during a listen interval corresponding to the broadcast TWT schedule.

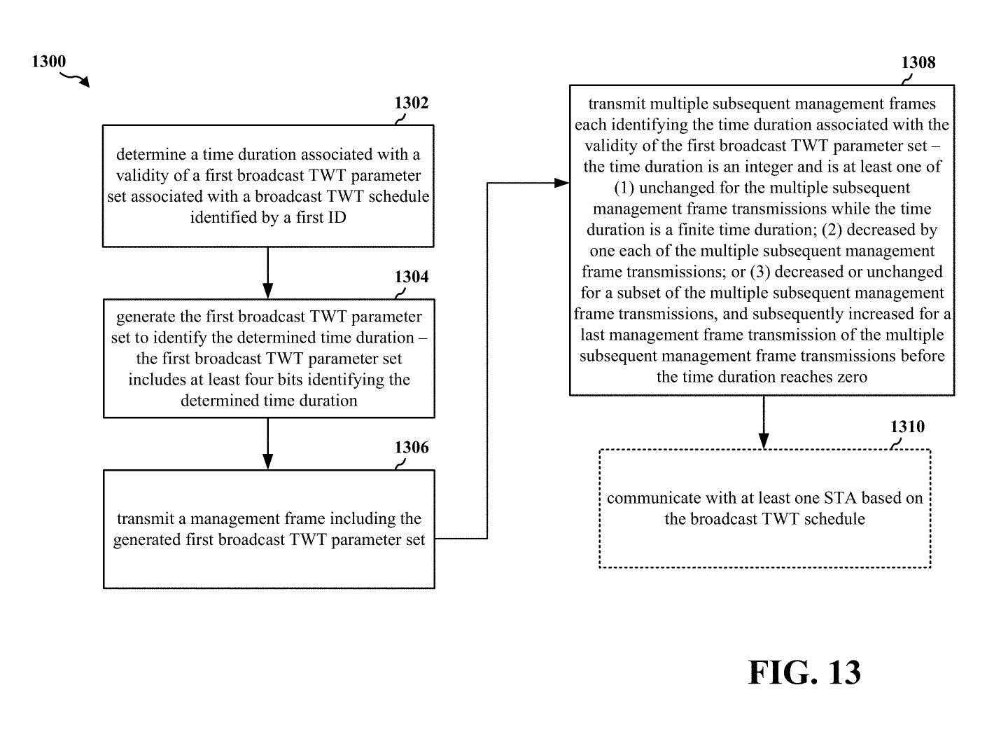

FIG. 13 shows a flowchart 1300 illustrating a third example process for an AP according to some implementations. The third example process may be performed by a wireless communication device at the AP, such as for example, the processor 210. At 1302, the AP determines a time duration associated with a validity of a first broadcast TWT parameter set associated with a broadcast TWT schedule identified by a first ID. For example, referring to FIG. 4, the AP 402 determines a time duration D associated with a validity (see validity windows 424a, 424b, 424c, 424d) of a first broadcast TWT parameter set 422 associated with a broadcast TWT schedule identified by a first ID 418. At 1304, the AP generates the first broadcast TWT parameter set to identify the determined time duration. The first broadcast TWT parameter set includes at least four bits identifying the determined time duration. For example, referring to FIG. 4, the AP 402 generates the first broadcast TWT parameter set 422 to identify the determined time duration D within the broadcast TWT persistence subfield 416. The first broadcast TWT parameter set 422 includes the broadcast TWT persistence subfield 416, which is at least four bits that identify the determined time duration D. At 1306, the AP transmits a management frame including the generated first broadcast TWT parameter set. For example, referring to FIG. 4, the AP 402 transmits management frame 420a-420g including the generated first broadcast TWT parameter set 422.

Assume at 1306, the AP transmits the management frame 420a. At 1308, the AP 402 transmits multiple subsequent management frames 420b-420g each identifying the time duration D associated with the validity (see validity windows 424a-424d) of the first broadcast TWT parameter set 422. The time duration D is an integer and is at least one of (1) unchanged for the multiple subsequent management frame transmissions while the time duration is a finite time duration (e.g., 420b, 420c); (2) decreased by one each of the multiple subsequent management frame transmissions (e.g., 420d-420g); or (3) decreased or unchanged for a subset of the multiple subsequent management frame transmissions (e.g., 420b-420f), and subsequently increased for a last management frame transmission of the multiple subsequent management frame transmissions before the time duration reaches zero. For (3), the AP 402 may increase the time duration D at any time before transmission of the management frame 420g with the time duration D=0.

At 1310, the AP 402 may communicate with at least one STA based on the broadcast TWT schedule. At 1312, the AP 402 may transmit DL MU PPDUs to the STA 404 during a listen interval corresponding to the broadcast TWT schedule.

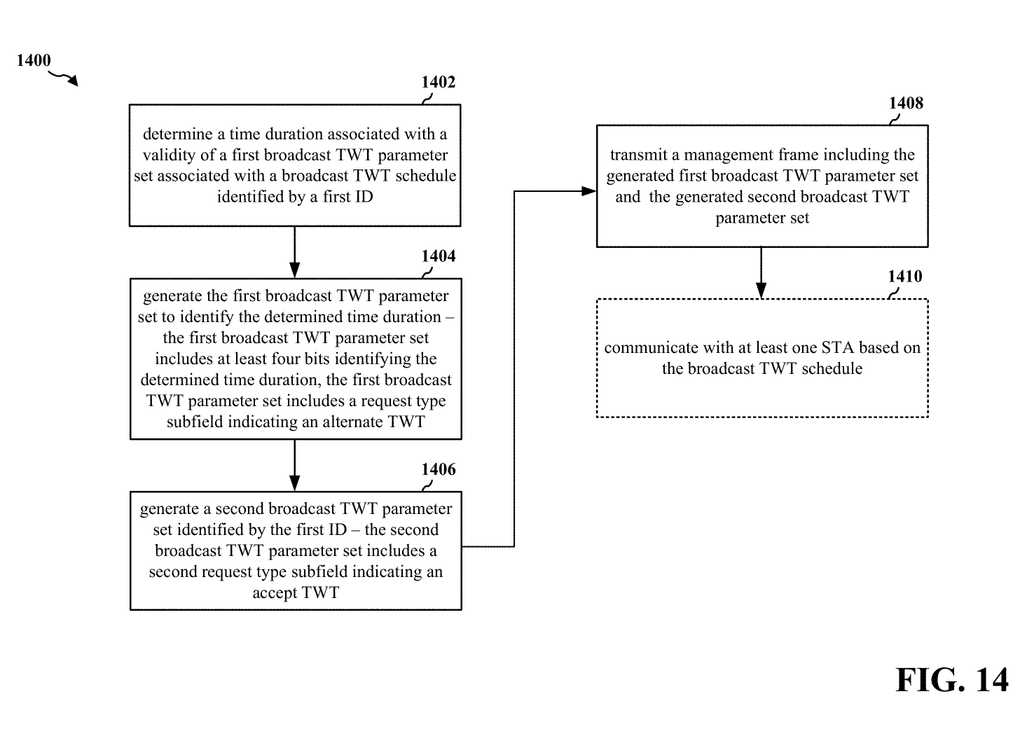

FIG. 14 shows a flowchart 1400 illustrating a fourth example process for an AP according to some implementations. The fourth example process may be performed by a wireless communication device at the AP, such as for example, the processor 210. At 1402, the AP determines a time duration associated with a validity of a first broadcast TWT parameter set associated with a broadcast TWT schedule identified by a first ID. For example, referring to FIGS. 4, 5, the AP 402 determines a time duration D associated with a validity (see validity windows 424a, 424b, 424c, 424d) of a first broadcast TWT parameter set 522a associated with a broadcast TWT schedule identified by a first ID 518. At 1404, the AP generates the first broadcast TWT parameter set to identify the determined time duration. The first broadcast TWT parameter set includes at least four bits identifying the determined time duration. The first broadcast TWT parameter set further includes a request type subfield indicating an alternate TWT. For example, referring to FIGS. 4, 5, the AP 402 generates the first broadcast TWT parameter set 522a to identify the determined time duration D within the broadcast TWT persistence subfield 516. The first broadcast TWT parameter set 522a includes the broadcast TWT persistence subfield 516, which is at least four bits that identify the determined time duration D. The first broadcast TWT parameter set 522a may further include a request type field 512 indicating an alternate TWT. As discussed above, the request type field 512 indicating alternate TWT indicates that one or more parameters in the first broadcast TWT parameter set will change subsequent to expiration of the determined time duration D.

At 1406, the AP 402 generates a second broadcast TWT parameter set 522b identified by the first ID 518. The second broadcast TWT parameter set 522b may include a second request type field 530 indicating an accept TWT. As discussed above, the request type field 530 indicating accept TWT indicates a new parameter set in the second broadcast TWT parameter set 522b that is applicable subsequent to expiration of the determined time duration D.

At 1408, the AP transmits a management frame including the generated first broadcast TWT parameter set 522a and the generated second broadcast TWT parameter set 522b. For example, referring to FIG. 4, the AP 402 transmits management frames 420a-420g that may include both the generated first broadcast TWT parameter set 522a and the generated second broadcast TWT parameter set 522b.

At 1410, the AP 402 may communicate with at least one STA based on the broadcast TWT schedule. At 1410, the AP 402 may transmit DL MU PPDUs to the STA 404 during a listen interval corresponding to the broadcast TWT schedule.

In a first configuration, an apparatus for wireless communication is provided. The apparatus may be a wireless communication device at a STA. The wireless communication device may be the processor 310 within the STA 300 or may be some other hardware within the STA 300. The apparatus may include means for receiving a management frame including a first broadcast TWT parameter set associated with a broadcast TWT schedule identified by a first ID. The first broadcast TWT parameter set identifies a first time duration associated with a validity of the first broadcast TWT parameter set. The first broadcast TWT parameter set identifies at least four bits indicating the first time duration. The apparatus may further include means for determining the validity of the first broadcast TWT parameter set based on the received first time duration.

In one configuration, the apparatus further includes means for refraining from monitoring subsequent management frames that include the first broadcast TWT parameter set for a second time duration based on the first time duration. In one configuration, the means for refraining from monitoring subsequent management frames is configured to enter into a power saving mode for the second time duration. Further, in such a configuration, to enter into the power saving mode, the means for refraining may enter into a sleep state in order to skip broadcast TWT SPs. The sleep state may be entered for the second time duration less than or equal to the first time duration. The management frame may be received from an AP. In one configuration, the apparatus further include means for monitoring signals from a device other than the AP or means for communicating with the device other than the AP. The means for monitoring or the means for communicating are concurrent with the subsequent management frames from the AP for the second time duration. In one configuration, the means for refraining from monitoring subsequent management frames is configured to refrain from processing a portion of or an entire subsequent management frame (which may be referred to as early beacon termination when the management frame is a beacon frame).

In one configuration, the apparatus may further include means for communicating with an AP based on the broadcast TWT schedule. The management frame may be one of a probe response frame, a broadcast probe response frame, an association response frame, a re-association response frame, a FILS discovery frame, a beacon frame with a periodicity of a beacon interval, or a beacon frame with a periodicity of a DTIM interval. The first time duration may indicate a number of intervals for which the first broadcast TWT parameter set is guaranteed to be valid. Each interval of the intervals may be a beacon interval corresponding to a beacon frame, or a DTIM interval corresponding to a beacon frame that includes a DTIM. The number of intervals may be a number of TBTTs of a beacon, or may be a number of beacons including a DTIM. The at least four bits may identify a value that indicates the number of intervals. The value may represent an integer number that is based on a linear function that represents up to 2^{N} intervals, where N is a number of bits of the at least four bits identifying the determined time duration, and N is greater than or equal to four.

In one configuration, the apparatus further includes means for receiving subsequent first management frames each identifying a respective time duration. Each time duration indicates a respective number of time intervals associated with the validity of the first broadcast TWT parameter set. The number of intervals indicated by the respective time duration may be decreased by one for each successive first management frame. The broadcast TWT schedule may be terminated after the time duration reaches zero. The apparatus may further include means for receiving a subsequent second management frame between two successive first management frames. The second management frame identifies a time duration indicating a respective number of time intervals associated with the validity of the first broadcast TWT parameter set. The time duration identified in the second management frame may be unchanged relative to the time duration identified in the previously received first management frame. In a first configuration, each of the first management frames is a beacon frame, and the second management frame is one of a probe response frame, a broadcast probe response frame, an association response frame, a re-association response frame, or a FILS discovery frame. In a second configuration, each of the first management frames is a beacon frame that includes a DTIM, and the second management frame is one of a probe response frame, a broadcast probe response frame, an association response frame, a re-association response frame, a FILS discovery frame, or a beacon frame that does not include a DTIM.

In one configuration, the apparatus further includes means for receiving multiple subsequent management frames each identifying the first time duration associated with the validity of the first broadcast TWT parameter set. In such a configuration, the first time duration is an integer and is at least one of (1) unchanged for the multiple subsequent management frame receptions while the first time duration is a finite time duration; (2) decreased by one each of the multiple subsequent management frame receptions; or (3) decreased or unchanged for a subset of the multiple management frame receptions, and subsequently increased for a last management frame reception of the multiple management frame receptions before the first time duration reaches zero.

In one configuration, the management frame may further include a second broadcast TWT parameter set identified by the first ID. In addition, the first broadcast TWT parameter set may include a request type subfield indicating an alternate TWT, and the second broadcast TWT parameter set may include a second request type subfield indicating an accept TWT. The request type subfield indicating alternate TWT indicates that one or more parameters in the first broadcast TWT parameter set will change subsequent to expiration of the determined first time duration. The request type subfield indicating accept TWT indicates a new parameter set in the second broadcast TWT parameter set that is applicable subsequent to expiration of the determined first time duration.

In a second configuration, an apparatus for wireless communication is provided. The apparatus may be a wireless communication device at an AP. The wireless communication device may be the processor 210 within the AP 200 or may be some other hardware within the AP 200. The apparatus may include means for determining a time duration associated with a validity of a first broadcast TWT parameter set associated with a broadcast TWT schedule identified by a first ID. The apparatus may further include means for generating the first broadcast TWT parameter set to identify the determined time duration. The first broadcast TWT parameter set may include at least four bits identifying the determined time duration. The apparatus may further include means for transmitting a management frame including the generated first broadcast TWT parameter set.

The management frame may be one of a probe response frame, a broadcast probe response frame, an association response frame, a re-association response frame, a FILS discovery frame, a beacon frame with a periodicity of a beacon interval, or a beacon frame with a periodicity of a DTIM interval. The time duration may indicate a number of intervals for which the first broadcast TWT parameter set is valid. Each interval of the intervals may be a beacon interval corresponding to a beacon frame, or a DTIM interval corresponding to a beacon frame that includes a DTIM. The number of intervals may be a number of TBTTs of a beacon, or may be a number of beacons including a DTIM. The at least four bits may identify a value that indicates the number of intervals. The value may represent an integer number that is based on a linear function that represents up to 2^{N} intervals, where N is a number of bits of the at least four bits identifying the determined time duration, and N is greater than or equal to four. In one configuration, the apparatus further includes means for transmitting subsequent first management frames each identifying a respective time duration. Each time duration may indicate a respective number of time intervals associated with the validity of the first broadcast TWT parameter set. The number of intervals indicated by the respective time duration may be decreased by one for each successive first management frame. The broadcast TWT schedule may be terminated after the time duration reaches zero. The apparatus may further include means for transmitting a subsequent second management frame between two successive first management frames. The second management frame identifies a time duration indicating a respective number of time intervals associated with the validity of the first broadcast TWT parameter set. The time duration identified in the second management frame may be unchanged relative to the time duration identified in the previously transmitted first management frame. In a first configuration, each of the first management frames is a beacon frame, and the second management frame is one of a probe response frame, a broadcast probe response frame, an association response frame, a re-association response frame, or a FILS discovery frame. In a second configuration, each of the first management frames is a beacon frame that includes a DTIM, and the second management frame is one of a probe response frame, a broadcast probe response frame, an association response frame, a re-association response frame, a FILS discovery frame, or a beacon frame that does not include a DTIM.

In one configuration, the apparatus further includes means for transmitting multiple subsequent management frames each identifying the time duration associated with the validity of the first broadcast TWT parameter set. In such a configuration, the time duration is an integer and is at least one of (1) unchanged for the multiple subsequent management frame transmissions while the time duration is a finite time duration; (2) decreased by one each of the multiple subsequent management frame transmissions; or (3) decreased or unchanged for a subset of the multiple subsequent management frame transmissions, and subsequently increased for a last management frame transmission of the multiple subsequent management frame transmissions before the time duration reaches zero.

In one configuration, the apparatus further includes means for generating a second broadcast TWT parameter set identified by the first ID. In such a configuration, the management frame may further include the generated second broadcast TWT parameter set. The first broadcast TWT parameter set may include a request type subfield indicating an alternate TWT. The second broadcast TWT parameter set may include a second request type subfield indicating an accept TWT. The request type subfield indicating alternate TWT indicates that one or more parameters in the first broadcast TWT parameter set will change subsequent to expiration of the determined time duration. The request type subfield indicating accept TWT indicates a new parameter set in the second broadcast TWT parameter set that is applicable subsequent to expiration of the determined time duration. In one configuration, the apparatus further includes means for communicating with at least one STA based on the broadcast TWT schedule.

Referring again to FIGS. 3-10, an exemplary wireless communication device (e.g., processor 310 or some other hardware at the STA 300) at a STA 300, 404, 604 is provided. The STA 300, 404, 604 receives a management frame 420a-420g, 660 including a first broadcast TWT parameter set 422, 522a associated with a broadcast TWT schedule identified by a first ID 418, 518. The first broadcast TWT parameter set 422, 522a identifies a first time duration D associated with a validity (see validity windows 424a-424d) of the first broadcast TWT parameter set 422, 522a. The first broadcast TWT parameter set 422, 522a identifies at least four bits (see broadcast TWT persistence subfield 416, 516) indicating the first time duration D. The STA 300, 404, 604 determines the validity of the first broadcast TWT parameter set 422, 522a based on the received first time duration D. Particular implementations of the subject matter described in this disclosure can be implemented to realize one or more of the following potential advantages. In some implementations, the described techniques can be used by the STA 300, 404, 604 to refrain from monitoring some management frames in order to sleep longer than the STA 300, 404, 604 would have been able to sleep otherwise, in order to save power at the STA 300, 404, 604, and/or in order to communicate with other devices (e.g., other STAs or other APs) concurrently while such management frames would have been received by the STA 300, 404, 604.

Referring again to FIGS. 2, 4-7, and 11-14, an exemplary wireless communication device (e.g., processor 210 or some other hardware at the AP 200) at an AP 200, 402, 602 is provided. The AP 200, 402, 602 determines a time duration D associated with a validity (see validity windows 424a-424d) of a first broadcast TWT parameter set 422, 522a associated with a broadcast TWT schedule identified by a first ID 418, 518. The AP 200, 402, 602 generates the first broadcast TWT parameter set 422, 522a to identify the determined time duration D. The first broadcast TWT parameter set 422, 522a includes at least four bits identifying the determined time duration D. The AP 200, 402, 602 transmits a management frame 420a-420g, 660 including the generated first broadcast TWT parameter set 422, 522a. Particular implementations of the subject matter described in this disclosure can be implemented to realize one or more of the following potential advantages. In some implementations, the described techniques are used by the AP 200, 402, 602 in order to allow the STA 300, 404, 604 to refrain from monitoring more management frames than the STA 300, 404, 604 would have been able to refrain from monitoring otherwise. The implementation by the AP 200, 402, 602 may therefore allow the STA 300, 404, 604 to sleep longer than the STA 300, 404, 604 would have been able to sleep otherwise, to save power at the STA 300, 404, 604, and/or to communicate with other devices (e.g., other STAs or other APs) instead of receiving such management frames.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a wireless communication device at a station (STA), comprising:
receiving a management frame including a first broadcast target wake time (TWT) parameter set associated with a broadcast TWT schedule identified by a first identifier (ID), the first broadcast TWT parameter set identifying a first time duration associated with a validity of the first broadcast TWT parameter set, the first broadcast TWT parameter set identifying at least four bits indicating the first time duration; and
determining the validity of the first broadcast TWT parameter set based on the received first time duration.

2. The method of claim 1, further comprising refraining from monitoring subsequent management frames that include the first broadcast TWT parameter set for a second time duration based on the first time duration.

3. The method of claim 2, wherein the refraining from monitoring subsequent management frames comprises entering into a power saving mode for the second time duration, and the entering into the power saving mode comprises entering into a sleep state in order to skip broadcast TWT service periods (SPs), the sleep state being entered for the second time duration less than or equal to the first time duration.

4. The method of claim 2, wherein the management frame is received from an access point (AP), and the method further comprises monitoring signals from a device other than the AP or communicating with the device other than the AP, the monitoring or the communicating being concurrent with the subsequent management frames from the AP for the second time duration.

5. The method of claim 2, wherein the refraining from monitoring subsequent management frames comprises refraining from processing a portion of or an entire subsequent management frame.

6. The method of claim 1, wherein the first time duration indicates a number of intervals for which the first broadcast TWT parameter set is valid.

7. The method of claim 6, wherein each interval of the intervals is a beacon interval corresponding to a beacon frame, or a delivery traffic indication message (DTIM) interval corresponding to a beacon frame that includes a DTIM.

8. The method of claim 6, wherein the number of intervals is a number of target beacon transmission times (TBTTs) of a beacon, or is a number of beacons including a delivery traffic indication message (DTIM).

9. The method of claim 6, wherein the at least four bits identify a value that indicates the number of intervals, the value representing an integer number that is based on a linear function that represents up to 2^{N} intervals, where N is a number of bits of the at least four bits identifying the determined time duration, and N is greater than or equal to four.

10. The method of claim 1, further comprising receiving subsequent first management frames each identifying a respective time duration, each time duration indicating a respective number of time intervals associated with the validity of the first broadcast TWT parameter set, wherein the number of intervals indicated by the respective time duration is decreased by one for each successive first management frame, and the broadcast TWT schedule is terminated after the time duration reaches zero.

11. The method of claim 10, further comprising receiving a subsequent second management frame between two successive first management frames, the second management frame identifying a time duration indicating a respective number of time intervals associated with the validity of the first broadcast TWT parameter set, wherein the time duration identified in the second management frame is unchanged relative to the time duration identified in the previously received first management frame.

12. The method of claim 11, wherein:
each of the first management frames is a beacon frame, and the second management frame is one of a probe response frame, a broadcast probe response frame, an association response frame, a re-association response frame, or a fast initial link setup (FILS) discovery frame; or
each of the first management frames is a beacon frame that includes a delivery traffic indication message (DTIM), and the second management frame is one of a probe response frame, a broadcast probe response frame, an association response frame, a re-association response frame, a FILS discovery frame, or a beacon frame that does not include a DTIM.

13. The method of claim 1, further comprising receiving multiple subsequent management frames each identifying the first time duration associated with the validity of the first broadcast TWT parameter set, wherein the first time duration is an integer and is at least one of (1) unchanged for the multiple subsequent management frame receptions while the first time duration is a finite time duration; (2) decreased by one each of the multiple subsequent management frame receptions; or (3) decreased or unchanged for a subset of the multiple management frame receptions, and subsequently increased for a last management frame reception of the multiple management frame receptions before the first time duration reaches zero.

14. The method of claim 1, wherein the management frame is one of a probe response frame, a broadcast probe response frame, an association response frame, a re-association response frame, a fast initial link setup (FILS) discovery frame, a beacon frame with a periodicity of a beacon interval, or a beacon frame with a periodicity of a delivery traffic indication message (DTIM) interval.

15. The method of claim 1, wherein:
the management frame further includes a second broadcast TWT parameter set identified by the first ID;
the first broadcast TWT parameter set includes a request type subfield indicating an alternate TWT;
the second broadcast TWT parameter set includes a second request type subfield indicating an accept TWT;
the request type subfield indicating alternate TWT indicates that one or more parameters in the first broadcast TWT parameter set will change subsequent to expiration of the determined first time duration; and
the request type subfield indicating accept TWT indicates a new parameter set in the second broadcast TWT parameter set that is applicable subsequent to expiration of the determined first time duration.

16. The method of claim 1, further comprising communicating with an access point (AP) based on the broadcast TWT schedule.

17. A wireless communication device for wireless communication at a station (STA), comprising:
at least one processor; and
at least one memory communicatively coupled with the at least one processor and storing processor-readable code that, when executed by the at least one processor, causes the wireless communication device to:
receive a management frame including a first broadcast target wake time (TWT) parameter set associated with a broadcast TWT schedule identified by a first identifier (ID), the first broadcast TWT parameter set identifying a first time duration associated with a validity of the first broadcast TWT parameter set, the first broadcast TWT parameter set identifying at least four bits indicating the first time duration; and
determine the validity of the first broadcast TWT parameter set based on the received first time duration.

18. The wireless communication device of claim 17, wherein the wireless communication device is further caused to refrain from monitoring subsequent management frames that include the first broadcast TWT parameter set for a second time duration based on the first time duration.

19. The wireless communication device of claim 17, wherein the first time duration indicates a number of intervals for which the first broadcast TWT parameter set is valid.

20. The wireless communication device of claim 17, wherein the wireless communication device is further caused to receive subsequent first management frames each identifying a respective time duration, each time duration indicating a respective number of time intervals associated with the validity of the first broadcast TWT parameter set, wherein the number of intervals indicated by the respective time duration is decreased by one for each successive first management frame, and the broadcast TWT schedule is terminated after the time duration reaches zero.

21. The wireless communication device of claim 17, wherein the wireless communication device is further caused to receive multiple subsequent management frames each identifying the first time duration associated with the validity of the first broadcast TWT parameter set, wherein the first time duration is an integer and is at least one of (1) unchanged for the multiple subsequent management frame receptions while the first time duration is a finite time duration; (2) decreased by one each of the multiple subsequent management frame receptions; or (3) decreased or unchanged for a subset of the multiple management frame receptions, and subsequently increased for a last management frame reception of the multiple management frame receptions before the first time duration reaches zero.

22. The wireless communication device of claim 17, wherein the management frame is one of a probe response frame, a broadcast probe response frame, an association response frame, a re-association response frame, a fast initial link setup (FILS) discovery frame, a beacon frame with a periodicity of a beacon interval, or a beacon frame with a periodicity of a delivery traffic indication message (DTIM) interval.

23. The wireless communication device of claim 17, wherein:
the management frame further includes a second broadcast TWT parameter set identified by the first ID;
the first broadcast TWT parameter set includes a request type subfield indicating an alternate TWT;
the second broadcast TWT parameter set includes a second request type subfield indicating an accept TWT;
the request type subfield indicating alternate TWT indicates that one or more parameters in the first broadcast TWT parameter set will change subsequent to expiration of the determined first time duration; and
the request type subfield indicating accept TWT indicates a new parameter set in the second broadcast TWT parameter set that is applicable subsequent to expiration of the determined first time duration.

24. The wireless communication device of claim 17, wherein the wireless communication device is further caused to communicate with an access point (AP) based on the broadcast TWT schedule.

25. An apparatus for wireless communication, the apparatus being a wireless communication device at a station (STA), comprising:
means for receiving a management frame including a first broadcast target wake time (TWT) parameter set associated with a broadcast TWT schedule identified by a first identifier (ID), the first broadcast TWT parameter set identifying a first time duration associated with a validity of the first broadcast TWT parameter set, the first broadcast TWT parameter set identifying at least four bits indicating the first time duration; and
means for determining the validity of the first broadcast TWT parameter set based on the received first time duration.

26. The apparatus of claim 25, further comprising means for refraining from monitoring subsequent management frames that include the first broadcast TWT parameter set for a second time duration based on the first time duration.

27. The apparatus of claim 25, further comprising means for receiving subsequent first management frames each identifying a respective time duration, each time duration indicating a respective number of time intervals associated with the validity of the first broadcast TWT parameter set, wherein the number of intervals indicated by the respective time duration is decreased by one for each successive first management frame, and the broadcast TWT schedule is terminated after the time duration reaches zero.

28. The apparatus of claim 25, further comprising means for receiving multiple subsequent management frames each identifying the first time duration associated with the validity of the first broadcast TWT parameter set, wherein the first time duration is an integer and is at least one of (1) unchanged for the multiple subsequent management frame receptions while the first time duration is a finite time duration; (2) decreased by one each of the multiple subsequent management frame receptions; or (3) decreased or unchanged for a subset of the multiple management frame receptions, and subsequently increased for a last management frame reception of the multiple management frame receptions before the first time duration reaches zero.

29. The apparatus of claim 25, further comprising means for communicating with an access point (AP) based on the broadcast TWT schedule.

30. A tangible computer-readable storage medium of a station (STA) comprising non-transitory processor-executable code operable to:
receive a management frame including a first broadcast target wake time (TWT) parameter set associated with a broadcast TWT schedule identified by a first identifier (ID), the first broadcast TWT parameter set identifying a first time duration associated with a validity of the first broadcast TWT parameter set, the first broadcast TWT parameter set identifying at least four bits indicating the first time duration; and
determine the validity of the first broadcast TWT parameter set based on the received first time duration.
